(19) United States
(12) Patent Application Publication
(10) Pub. No.: US 2024/0116014 A1
(43) Pub. Date: Apr. 11, 2024

(54) Liquid dispensing apparatus for controllable mixing of liquids

(71) Applicant: KING'S FLAIR MARKETING LIMITED, Tortola (VG)

(72) Inventors: Siu Wah WONG, Tortola (VG); Fat Sun KWOK, Tortola (VG)

(21) Appl. No.: 18/371,187

(22) Filed: Sep. 21, 2023

Related U.S. Application Data
(60) Provisional application No. 63/414,139, filed on Oct. 7, 2022.
(60) Provisional application No. 63/437,214, filed on Jan. 5, 2023.

(51) Int. Cl. B01F 33/84; B01F 35/00; B67D 1/00

(52) U.S. Cl. CPC B01F 33/844; B01F 35/187; B67D 1/0017; B01F 2101/14

(57) ABSTRACT

The present invention provides a liquid dispensing apparatus, for use with a first container where a first liquid is contained, comprising: (a) a second container where a second liquid is contained, said second container is provided with a container outlet for dispensing said second liquid; and (b) a utility potion, comprising: an outlet, for dispensing liquid; a first inlet, collaboratively operating with a pressure valve for intaking said first liquid enabling a first passageway; and a second inlet, operatively working with said container outlet, enabling a second passageway for controllably intaking said second liquid from said second container to said second inlet.

### FIELD OF THE INVENTION

This invention relates to a liquid dispensing apparatus for dispensing liquids. Specifically, the present invention allows users to choose dispensing a first liquid or a mixing between the first liquid and a second liquid according to their need. More specifically, the invention allows users to adjust the concentration of the first liquid to be mixed and the second liquid to be mixed for mixing.

### BACKGROUND OF THE INVENTION

There is a growing interest and desire among consumers for unique and engaging experiences related to beverages. Rather than merely consuming a beverage for its taste or functionality. Taking drinking bottles as an example, during exercise, individuals often require energy drinks to supplement their physical strength. These energy drinks are typically prepared by diluting a concentrate. However, most drinking bottles on the market can only accommodate a single type of beverage. As a result, when these bottles are filled with energy drinks, they cannot simultaneously hold another beverage such as water. This inconvenience forces users to carry an additional drinking bottle solely for water. Taking beverage machine as an example, which is a versatile device designed to accommodate water and a variety of concentrates for preparing different flavored beverages. The conventional beverage dispensers available in the market while allow for mixing of different liquids, they often lack the ability to modify the concentration of the individual components.

To address these issues and provide an alternative solution, the present invention introduces a liquid dispensing apparatus that can be assembled into a bottle, thereby capable of containing at least two liquids; or can be used in a beverage machine. Users can select the desired type of liquid they need, offering enhanced convenience. Furthermore, the present invention allows for the mixing of these liquids during consumption, providing an added advantage. Most notably, the invention enables users to control the concentration of the mixed liquids while drinking, further enhancing their experience.

### SUMMARY OF INVENTION

The present invention relates to a liquid dispensing apparatus, for use with a first container where a first liquid is contained, comprising: (a) a second container where a second liquid is contained, said second container is provided with a container outlet for dispensing said second liquid; and (b) a utility potion, comprising: an outlet, for dispensing liquid; a first inlet, collaboratively operating with a pressure valve for intaking said first liquid enabling a first passageway; and a second inlet, operatively working with said container outlet, enabling a second passageway for controllably intaking said second liquid from said second container to said second inlet.

In some embodiments, said pressure valve positioned adjacent said first inlet and works with a defined pressure, during a user sucks the first liquid at said outlet of said utility potion, the first liquid in said first container being flown through said pressure valve towards said outlet when the pressure-drop inside said utility potion exceeding the value of said defined pressure. Preferably, at the moment when the pressure-drop inside said utility potion exceeding the value of said defined pressure, the second liquid in said second container is selectively flowable through said container outlet towards said second inlet, thereby the first liquid and the second liquid being mixed in said utility potion.

In some embodiments, said liquid dispensing apparatus comprising an adjustment means for adjusting the volumetric flow in said second passageway, thereby controllably adjusting said second liquid flowing through said container outlet towards said second inlet.

Preferably, said second passageway is configurable to stop said second liquid flowing through said container outlet towards said second inlet.

In some embodiments, said liquid dispensing apparatus further comprising a buffer tank designed to provide a channel connecting said second inlet of said utility potion and said container outlet, said adjustment means is a T-shaped button having a top surface and a leg extending downwards therefrom, said leg is provided with a through-opening, said T-shaped button assembled to said buffer tank such that said leg of said T-shaped button is rotatable in said channel between a first configuration, where said through-opening being in fluid communication with said channel, and a second configuration, where said through-opening being not in fluid communication with said channel.

In some embodiments, said liquid dispensing apparatus further comprising a tube connecting said second inlet of said utility potion and said container outlet, said adjustment means is assembled to said liquid dispensing apparatus to encompass said tube, wherein said adjustment means comprising a slot and a handle slidable therein, said handle is provided with a protrusion such that said protrusion slidable over said tube between a first position and a second position, wherein the internal tubular cavity of said tube is smaller when said protrusion being at said first position comparing with said protrusion being at said second position.

In some embodiments, said liquid dispensing apparatus further comprising a tube connecting said second inlet of said utility potion and said container outlet, said adjustment means having an eccentric cylindrical profile being arranged adjacent said tube, and being rotatable with respect to said tube, wherein the internal tubular cavity of said tube is adjustable by rotating said adjustment means.

In some embodiments, said utility potion is provided with a straw having a outlet connecting to said first inlet of said utility potion; and a first inlet extending toward the vicinity of the bottom of said first container.

In some embodiments, said liquid dispensing apparatus further comprising a mixing chamber and a buffer tank, characterized in that, in said second passageway there is fluidic communication between said second container, said buffer tank, and said mixing chamber.

Preferably, the liquid in either said first passageway or said second passageway flowing through said mixing chamber.

More preferably, said utility portion is part of a lid member for said first container.

In some embodiments, said liquid dispensing apparatus further comprising (a) a mixing chamber and a buffer tank, wherein: (i) said utility portion is part of a lid member for said first container, wherein said lid member is profiled to accommodate said mixing chamber and said buffer tank; (ii) said mixing member is adjacent said first inlet of said utility portion; and said buffer tank is adjacent said second inlet of said utility portion, and is provided with an inlet and an outlet; (b) said outlet of said utility portion has a cylindrical profile extending upwards from the top side of said utility portion; (c) said adjustment means is rotatable about said outlet of said utility portion and is provided with a through-opening, thereby said through-opening being slidable over said inlet of said buffer tank; and (d) said second container is rotatable about said outlet of said utility portion and is positioned above said adjustment means, said container outlet is profiled to be received in said through-opening of said adjustment means.

Preferably, the liquid in either said first passageway or said second passageway flowing through said mixing chamber.

Preferably, said mixing member is profiled to accommodate said pressure valve, and said pressure valve is positioned adjacent said first inlet.

Preferably, said mixing member is profiled to accommodate a mounting member to which said pressure valve is mounted.

Preferably, the side of said buffer tank on which said inlet provided is designed to provide a groove, wherein said inlet of said buffer tank is provided at a first end of said groove. Advantageously, said groove of said buffer tank is provided with a second end, wherein the width of said groove is designed to be narrowing from said first end towards said second end; and/or the depth of the groove is designed to be decreasing from said first end towards said second end.

Preferably, the top side of said utility portion is provided with a groove; said adjustment means is provided with a protrusion sized and shaped to slide in said groove of said utility portion.

Preferably, further comprising a ring member, wherein the internal surface of said ring member is provided with a first threading member, said second container is designed to provide a central bore in which said ring member is removably mounted, the peripheral of said outlet of said utility portion is provided with a second threading member engageable with said second threading member; thereby said second container mounted to said outlet of said utility portion via said ring member.

Advantageously, by means of the coupling between said first threading member and said second threading member, said ring member being screwable upwards or downwards about said outlet of said utility portion.

More advantageously, said ring member is configurable to position between a first position where said ring member and said second container is being closer to said utility portion and a second position where said ring member and said second container is being away from said utility portion.

Most advantageously, said lid member is provided with a gas vent.

In some embodiments, the second liquid is in a form of disposable packaging, being received in said second container.

In some embodiments, said first container is part of a beverage dispenser.

Preferably, said beverage dispenser further comprising a nano-filter and an electric pump, said pressure valve collaboratively operating with said electric pump.

Advantageously, said beverage dispenser is equipped with a control panel for operating said beverage dispenser.

More advantageously, said control panel is configured to operate said electric pump.

Optionally, said nano-filter comprising nanofiber and/or activated carbon materials.

Selectively, the adjustment means is a turning dial that offers control over the mixing concentrate between the first liquid and the second liquid.

More selectively, said second container is disposable and/or the tube connecting said electric pump and said first container is disposable and/or the dispensing outlet of said beverage dispenser is disposable, providing advantage to prohibit bacteria growth in said beverage dispenser.

### DESCRIPTION OF THE DRAWINGS

Some embodiments of the present invention will now be explained, with reference to the accompanied drawings, in which:

FIG. 1 shows a first embodiment of a bottle with a first embodiment of a lid assembly;

FIG. 2 shows the bottle in FIG. 1 but with a lid cover removed;

FIG. 3 shows the cross-section of a base member of the first embodiment;

FIG. 4 shows a sectional view on a lid member of the first embodiment;

FIG. 5 shows a first embodiment of a second container;

FIG. 6 shows a sectional view on the second container;

FIG. 7 is a sectional view of part of the first embodiment in FIG. 2;

FIG. 8 shows a close-up view of a first embodiment of a utility portion;

FIG. 9 shows a sectional view of a first embodiment of a drinking member;

FIG. 10 shows that the lid assembly is provided with a pouch of fruit juice;

FIG. 11 is an exploded view on the first embodiment of the bottle in FIG. 1;

FIG. 12 shows that the lid assembly of the first embodiment is provided with an adjustment means of the present invention;

FIG. 13A-C shows a first embodiment of the adjustment means of the present invention with different perspective views;

FIG. 14A is an exploded view showing a drinking member, the adjustment means in FIGS. 13A-C, a second lid member, the pouch of fruit juice, and a buffer tank;

FIG. 14B shows a sectional view of part of the lid assembly;

FIG. 15A shows the adjustment means in FIGS. 13A-C is at the “closed” state;

FIG. 15B shows the state of a channel when the adjustment means is in the state of FIG. 15A;

FIG. 15C shows the adjustment means in FIGS. 13A-C is at the “max” state;

FIG. 15D shows the state of the channel when the adjustment means is in the state of FIG. 15C;

FIG. 16 shows another embodiment of the adjustment means of the present invention;

FIG. 17 is an exploded view showing the drinking member, the adjustment means in FIG. 16, the second lid member, the pouch of fruit juice, and the second container;

FIG. 18 shows a sectional view of the assembly comprising the second embodiment of the adjustment means;

FIGS. 19A-D show variants of embodiments of the bottle having the second container in different positions;

FIG. 20 is the second embodiment of the lid assembly;

FIGS. 21A-C shows a second embodiment of the valve with different views;

FIGS. 22A-C shows a mounting member of the present invention with different views;

FIGS. 23A-E shows a first embodiment of a mixing member of the present invention with different views;

FIGS. 24A-C shows a second embodiment of the lid member of the present invention with different views,

FIG. 25A shows the assembling of the mixing member to the lid member;

FIG. 25B is a sectional view of the assembly in FIG. 25A;

FIG. 25C shows the assembling of a buffer tank to the lid member;

FIGS. 26A-D shows the buffer tank with different views;

FIG. 27A is a first view showing the assembly between the valve, the valve mounting member, the mixing member, the lid member, the spout, and the buffer tank;

FIG. 27B is a second view showing the assembly between the valve, the valve mounting member, the mixing member, the lid member, the spout, and the buffer tank;

FIGS. 28A-D shows a first embodiment of an adjustment member of the present invention with different views;

FIGS. 29A-C are schematic drawings showing the assembling of the adjustment member on the lid member, in which the adjustment member is in different position;

FIGS. 30A-C shows a second embodiment of the second container of the present invention with different views;

FIGS. 31A-C shows a ring member of the present invention with different views;

FIG. 32A a perspective view of the assembly between the ring member and the second container in the second embodiment;

FIG. 32B is a sectional view of the assembly between the ring member and the second container in the second embodiment;

FIG. 33 is an exploded view on the second embodiment in FIG. 20;

FIG. 34 shows a third embodiment of the lid assembly;

FIGS. 35A-C shows a gas vent with different view;

FIGS. 36A-C shows a lid member with different views;

FIGS. 37A-B shows a second embodiment of the mixing member of the present invention with different views;

FIGS. 38A-B shows a second embodiment of the adjustment member of the present invention with different views;

FIGS. 39A-C shows a third embodiment of the second container of the present invention with different views;

FIG. 40A is a bottom view showing the assembling of the gas vent and the mixing chamber to the lid member;

FIG. 40B is a perspective bottom view showing the assembling of the gas vent and the mixing chamber to the lid member;

FIG. 41 is an exploded illustration of the third embodiment of the lid assembly, in a perspective top view;

FIG. 42 is an exploded illustration of the third embodiment of the lid assembly, in a perspective bottom view;

FIG. 43 shows another embodiment of a bottle with another embodiment of the lid assembly; and

FIG. 44 is a schematic drawing showing the operation of a beverage dispenser.

### DETAILED DESCRIPTION OF PREFERRED EMBODIMENTS OF THE INVENTION

The present invention is now presented by way of examples with reference to the figures in the following paragraphs. Objects, features, and aspects of the present disclosure are disclosed in or are apparent from the following description. It shall be understood by one of ordinary skilled in the art that the following description is a description of exemplary embodiments only, and is not intended as limiting the broader aspects of the present disclosure, which broader aspects are embodied in the exemplary constructions.

It should be noted that, unless otherwise defined, the technical terms or scientific terms used in the embodiments of the present invention shall have the usual meanings understood by person with ordinary skills in the art to which the present invention belongs. “First”, “second” and similar expression used in the embodiments of the present invention do not indicate any order, quantity or importance, but are only used to distinguish different components. “Front”, “rear”, “left”, “right”, “upper”, and “lower” and other terms indicating orientation or similar terms are only described for the exemplary relative positional relationship shown in the drawings to facilitate the understanding. It does not limit the disclosed components in the present invention can only follow this specific relative positional relationship. “Connect or the like”, “mount or the like” or “secure or the like” or “assemble or the like” is not limited to physical or mechanical connections, whether direct or indirect.

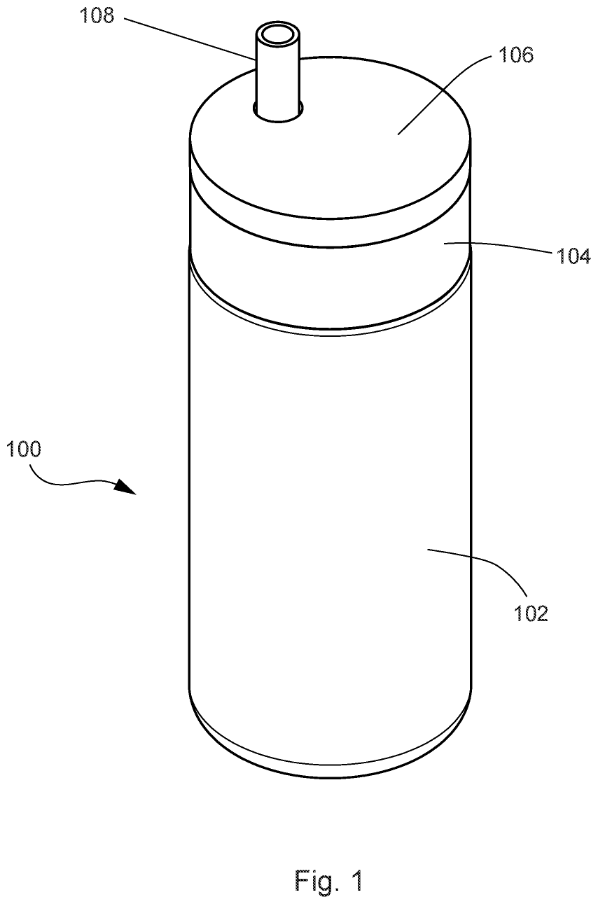

FIG. 1 shows a bottle denoted with reference numeral 100. The bottle 100 comprises a base member 102, a lid member 104, and a lid cover 106. It can be seen, in FIG. 1, a utility portion 108 vertically and outwardly extending beyond the lid cover 106 allows users to drink the liquid contained in the bottle 100. It can be understood that although the utility portion 108 extends vertically and outwardly beyond the lid cover 106, those skilled in the art could directly and unambiguously understand that the utility portion 108 is not necessary required to extend vertically and outwardly beyond the lid cover 106. Upon users' needs on the bottle 100, the utility portion 108 can be designed and/or configured, with common well-known means, to be hided/stored under the lid cover 106 or even be disassembled, and thus is out of sight, preventing the utility portion 108 from contamination.

It should be understood that in the context of this invention, when the lid member 104 is assembled to the base member 102, it indicates the lid member 104 is on top of or above the base member 102, allowing the general understanding on terms such as “up and down”, “above and under”, “left and right”, “front and rear”, “top and bottom”, “horizontal, vertical/vertical”, “high and low” are used in this context to express relative direction or location, definition of which is equivalent to the spatial arrangement illustrated in the figures in a direction into the sheet of figures.

The cross section of the lid member 104 is sized and shaped corresponds to the cross section of the base member 102, and thus the lid member 104 is assembled on top of the base member 102 by common closure means such as screw closure or quick-fit well known in the art. For brevity purpose, the closure means is well understood by those skilled in the art and thus is not explained in details herein.

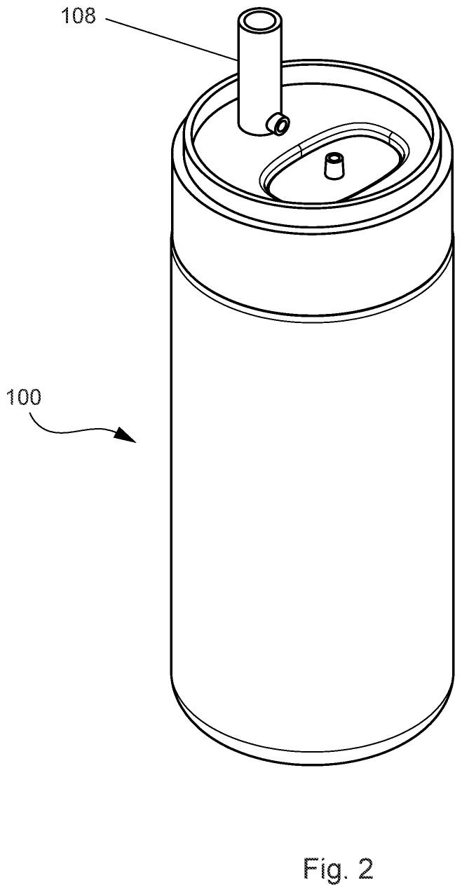

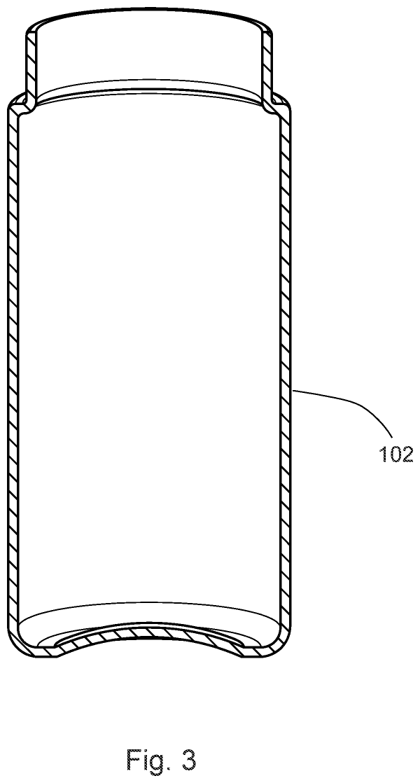

FIG. 2 shows the bottle 100 without covered by the lid cover 106. FIG. 3 shows a sectional view on the base member 102. Circumferential walls and the bottom of the base member 102 define a cavity allowing the base member 102 to contain a first liquid. The first liquid, for example, is water. It shall be understood that the base member 102 also refers to a first container.

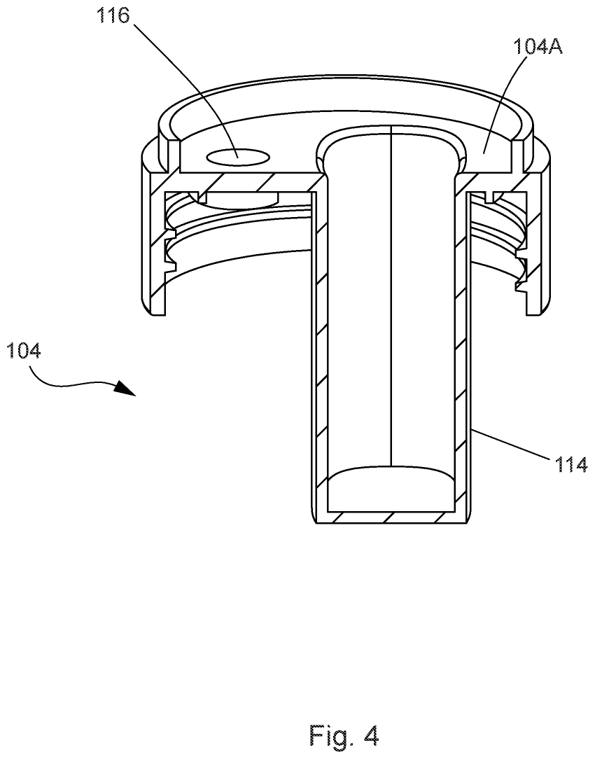

FIG. 4 shows a sectional view on the lid member 104. It can be seen that the lid member 104 is configured to recess downwardly from its surface 104A to form a receptacle 114. By definition, “recess downwardly from its surface to define a receptacle” in the context of this invention refers to configuring the lid member 104 to provide a receptacle 114 which is formed under the surface 104A of the lid member 104. It can be seen that the surface 104A of the lid member 104 is provided with an aperture 116, adjacent the receptacle 114, allowing the utility portion 108 passing therethrough.

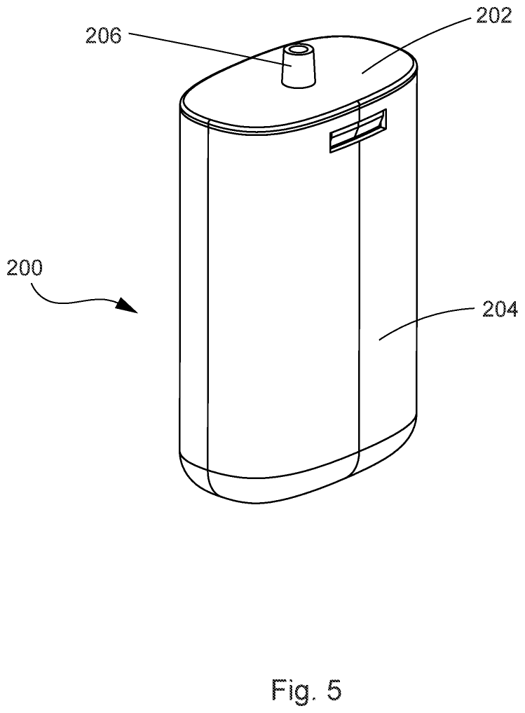

The bottle 100 is provided with a second container 200 as illustrated in FIG. 5. The second container 200 comprises a second lid cover 202 and a second base member 204. As seen, the outwardly facing top surface of the second lid cover 202 is provided with an outlet 206 for the second container 200.

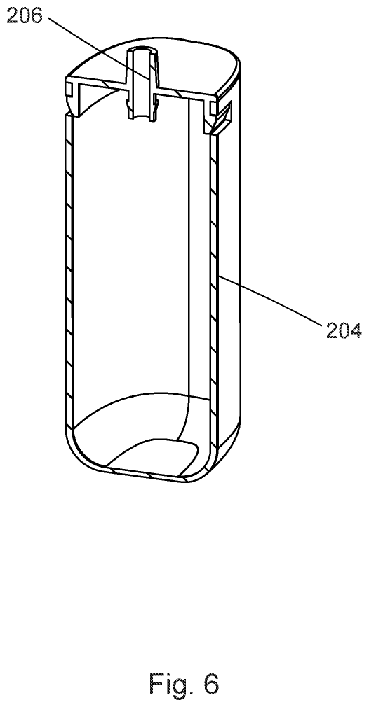

Circumferential walls and the bottom of the second base member 204 define a cavity, as illustrated in FIG. 6. In one embodiment, the cavity is configured to accommodate, for example, a pouch of liquid such as fruit juice or sport drink. It shall be understood that the pouch of liquid can be ready bought in convenient store, therefore users can choose placing different taste of fruit juice or sport drink in the second container 200. Different packaging other than a form of pouch is also suitable in use for the second container 200 according to the present invention. In another embodiment, the cavity is configured to accommodate liquid such as fruit juice or sport drink. In this embodiment, users can pour fruit juice or sport drink directly into the second container 200.

It shall be understood that these embodiments are for illustrative purpose only and shall not be interpreted as limitation on the second container 200 to accommodate fruit juice or sport drink, collectively understood as a second liquid, which can be optionally different from the first liquid as described above contained in the base member 102.

After filling the second base member 204 with the second liquid, the second base member 204 is closed and sealed with the second lid cover 202.

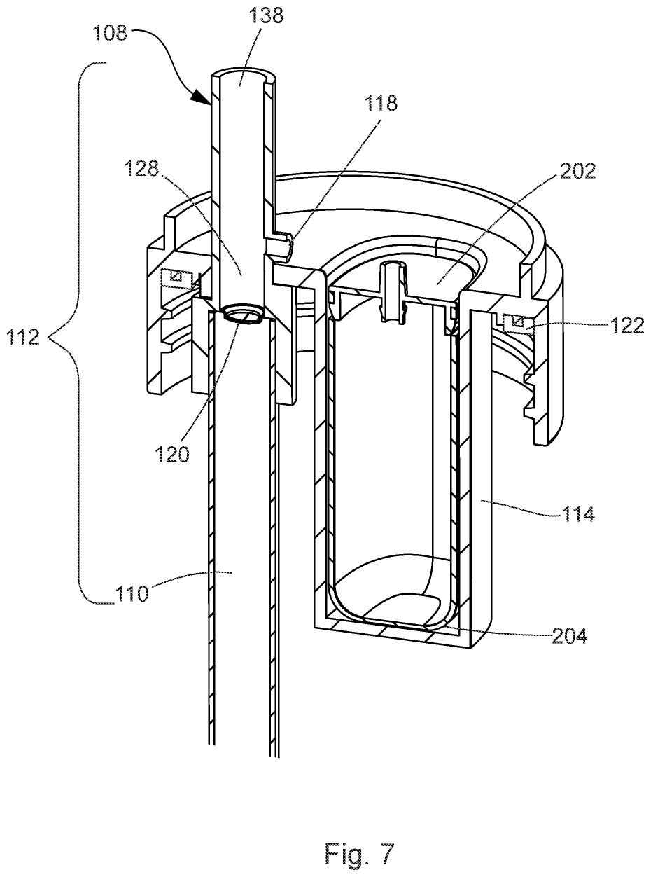

FIG. 7 shows the assembling of a drinking member 112 and the second container 200 to the lid member 104. It can be seen that the liquid dispensing apparatus of the present invention is part of the lid assembly to the bottle. A gasket 122 in O-shaped, also called as a lid rubber ring, is arranged internally around the circumference of the lid member 104. For brevity, the second container 200 is empty in FIG. 7. The drinking member 112 is defined by the assembly between the utility portion 108 and a straw 110. It can be seen in FIG. 7, the utility portion 108 is provided with an outlet 138 for user to suck the liquid or beverage, and a first inlet 128 opposite to the outlet 138. Adjacent the first inlet 128 is provided with a pressure valve 120.

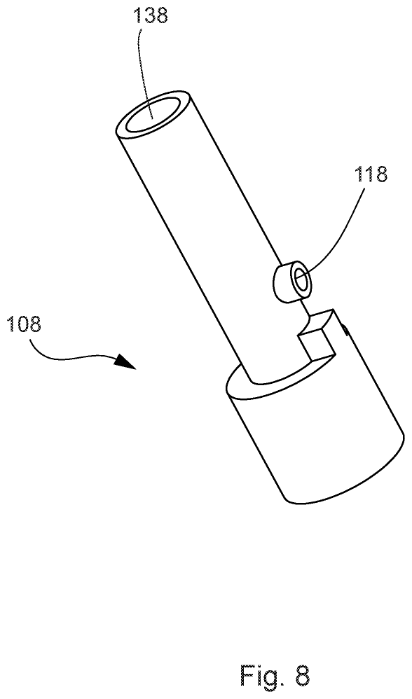

Still on FIG. 7, the utility portion 108 is further provided with a second inlet 118, which is in fluid communication with the utility portion 108. In one embodiment, the second inlet 118 is configured as a protrusion outwardly extending away from the body of the utility portion 108. FIG. 8 shows a close-up view on utility portion 108 with the second inlet 118.

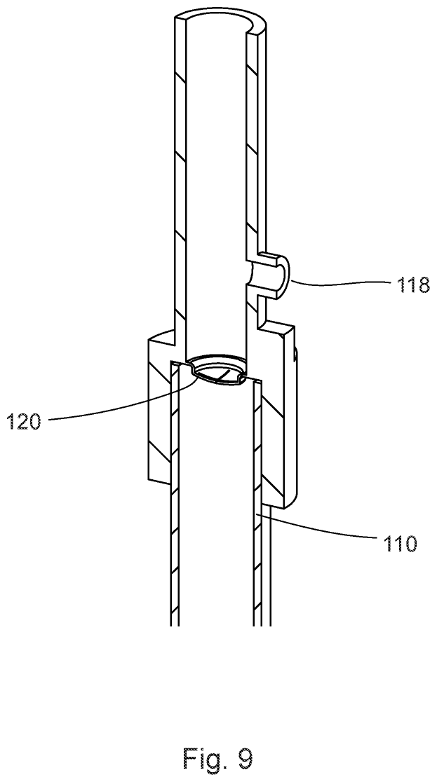

FIG. 9 shows a sectional view on the drinking member 112 according to one embodiment of the invention. It shows that the utility portion 108 is provided with the pressure valve 120, adjacent the first inlet 128 and is positioned between the utility portion 108 and the straw 110 in FIG. 9. The valve 120 in this embodiment is provided with slits in a cruciform. The position and the configuration of the pressure valve 120 in FIG. 9 is for illustrative purpose only and shall not be understood as a limitation on the use of valve 120 when practicing the invention.

In one embodiment for illustrative purpose, the drinking member 112 is provided with the valve 120 characterized with a valve opening pressure at 5 kPa. It means that during users suck the water in the base member 102 with the outlet 138 of the utility portion 108 of the drinking member 112, when the pressure-drop inside the utility portion 108 starts to exceeds 5 kPa, i.e. the pressure difference between the pressure in utility portion 108 and the pressure in straw 110 starts to over 5 kPa, the water in the base member 102 starts being drawn upwards by the straw 110, defining a first passageway for the water flowing from the base member 102 to the outlet 138 of the utility portion 108.

It shall be understood that the opening pressure 5 kPa in this embodiment is for illustrative purpose only, and it shall also be understood that the opening pressure of the valve could be modified or changed according to actual needs with common means in the art. For brevity purpose, the common means for modifying or changing the valve opening pressure is not explained in details herein. The advantage for the valve 120 is that it can ensure the water flowing out of the base member 102 only until the pressure difference between the pressure inside utility portion 108 and the pressure inside the straw 110 reaches certain level due to suction effect, produced by users.

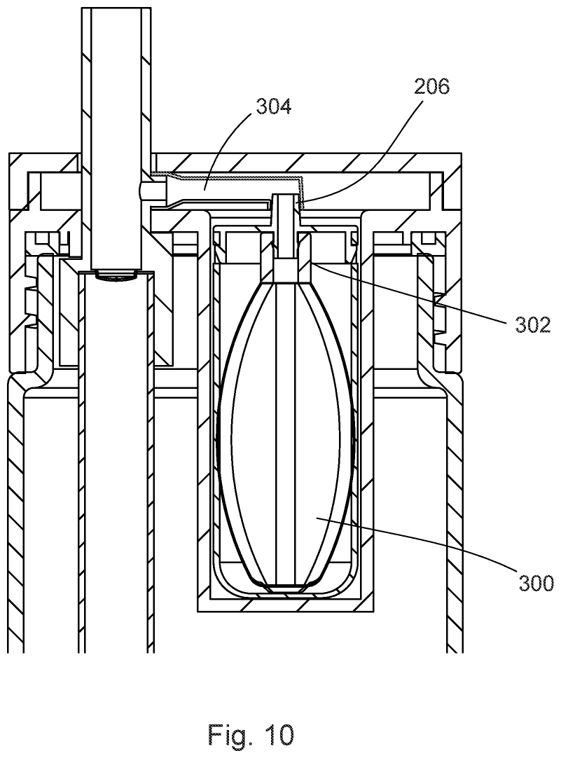

FIG. 10 shows the assembling of a drinking member 112 and the second container 200 to the lid member 104, in which the drinking member 112 and the second container 200 is connected with a tube 304. For illustration, the second container 200 is provided with a pouch of fruit juice 300. In this embodiment, it can be seen that the outlet 206 and a drinking nozzle 302 of the pouch of fruit juice 300 are mutually connected in a fluid communicable relationship, which can be realized, for example, by inserting a tube/straw between the drinking nozzle 302 and the outlet 206.

FIG. 11 shows an exploded view on the embodiment in FIG. 1.

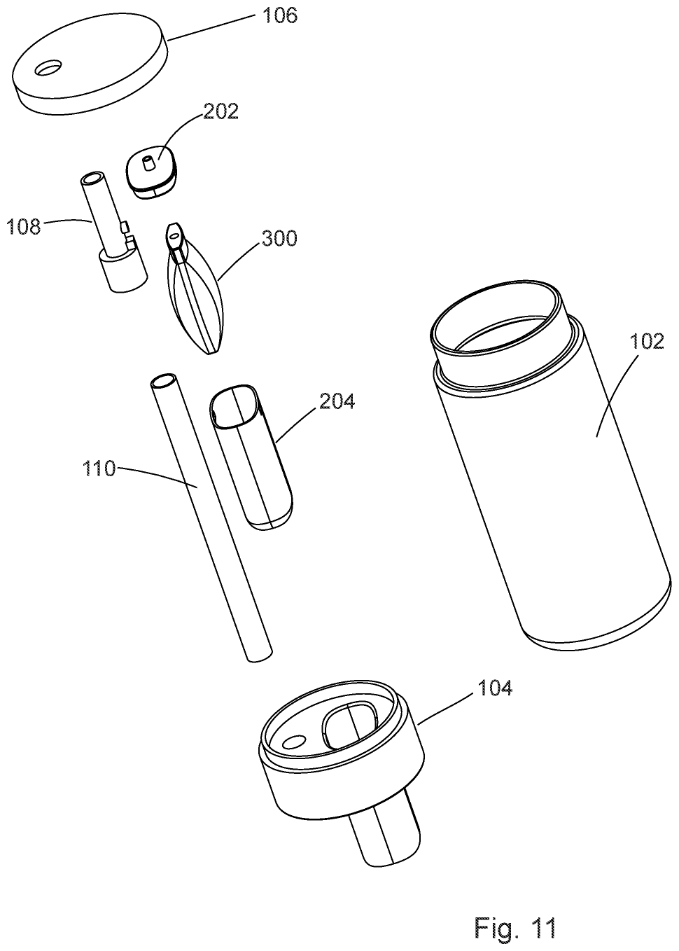

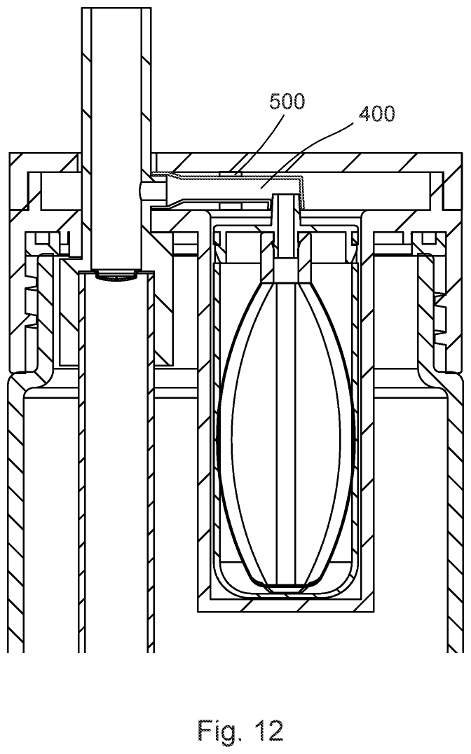

FIG. 12 shows an embodiment in which the second inlet 118 of the utility portion 108 and the outlet 206 of the second container, where a pouch of fruit juice is placed, are fluidly connected selectively with a tube 400, preferably made in silicone. As seen, the outlet 206 and a drinking nozzle of the pouch of fruit juice are mutually connected in a fluid communicable relationship, for example, with a tube/straw therebetween. It shall be understood that the tube 400 is an example only, the direct or indirect fluid connection between the first container and the second container can be realized by any common means.

When users suck the water in the base member 102 with the utility portion 108 of the drinking member 112, which is for example provided with the valve 120 as described above. With description above, it shall be understood that the main body of the utility portion 108 and the valve 120 together defines a cavity within the utility portion 108. When the user sucks the water with the utility portion 108 at the outlet 138 thereof, the pressure in said cavity is reduced. Taking valve 120 as an example, when the pressure-drop inside the utility portion 108 starts to exceeds 5 kPa, the water in the base member 102 starts being drawn fast and upwards by the straw 110 towards utility portion 108. Such fast upwards movement of the water through the utility portion 108 leads to a venturi effect at the second inlet 118 and thus the pressure at the second inlet 118 is reduced. Due to venturi effect, the fruit juice is then drawn upwards leaving the second container 200 and then passed through tube 400 to arrive utility portion 108 via the second inlet 118, defining a second passageway. Inside the utility portion 108, the fruit juice meets the water. Accordingly, the water and the fruit juice are mixed in the utility portion 108.

With contents described above, it shall be understood that the liquid dispensing apparatus according to the present invention comprises the utility portion 108, in fluidic communication with a first liquid contained in the base member 102 (a first container); a second container 200, where a second liquid is stored, is in fluidic communication with the drinking member 112. Operation of the liquid dispensing apparatus refers to the contents described above.

The liquid dispensing apparatus can also be used without using a straw connected to the utility portion 108. In this way, when the liquid dispensing apparatus of the present invention is assembled to the container, it works like a baby bottle when the liquid dispensing apparatus is in use. In other words, when the liquid dispensing apparatus works in this way, the liquid dispensing apparatus shown in FIGS. 1-12 is upside down. In some embodiments, the liquid dispensing apparatus can also be used in a beverage machine, which will be explained further in context below.

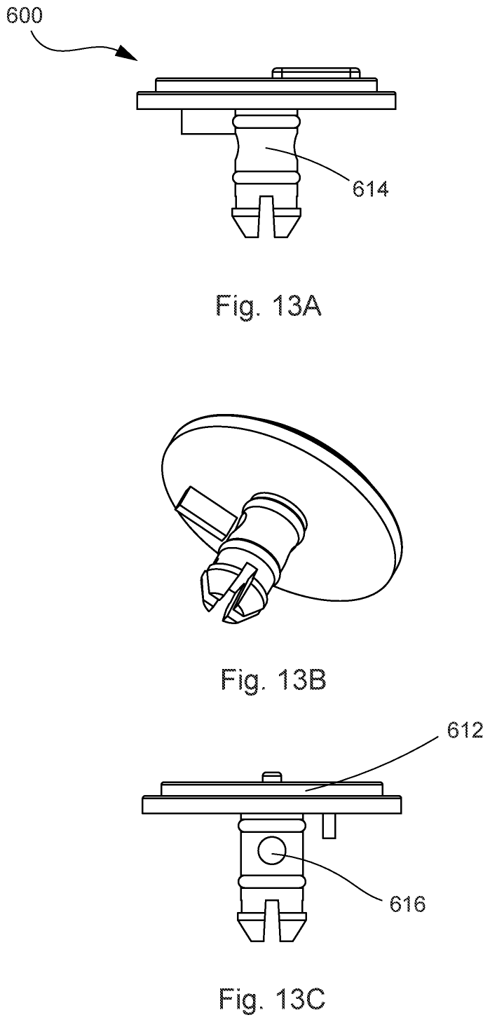

Advantageously, the liquid dispensing apparatus is provided with an adjustment means 500. The adjustment means is configured to operatively work on the volumetric flow in the second passageway between the second inlet 118 and the outlet 206. It shall be understood that the invention can be practiced without the adjustment means 500. In one embodiment, the adjustment means 500 is illustrated in FIGS. 13A-C with different angles. As shown, the adjustment means 500 in this embodiment is configured in a form of a T-shaped button 600 with a leg 614 extending downwards from its surface 612. The leg 614 is provided with a through-opening 616 traversing the longitudinal axis of the leg 614. In one embodiment, the through-opening 616 allows a tube passing through, said tube connects the second inlet 118 and the outlet 206.

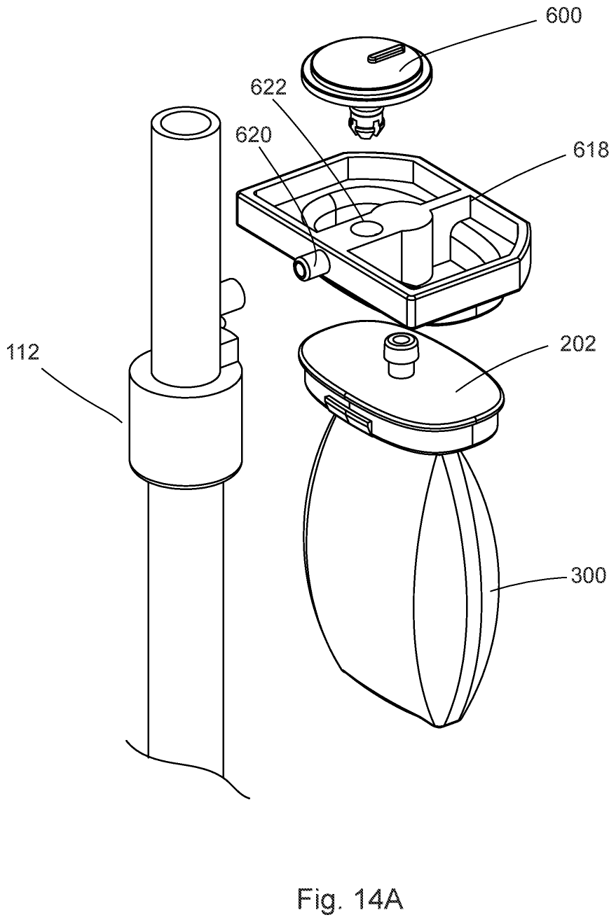

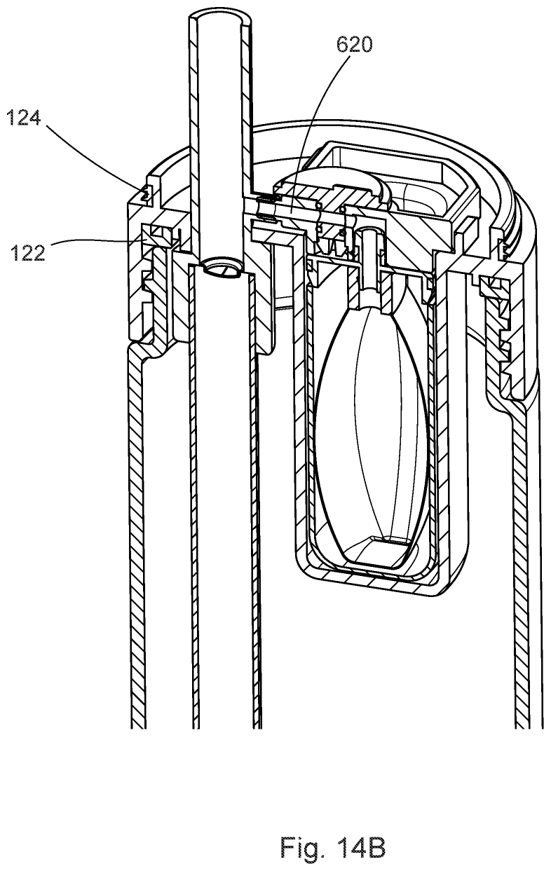

FIG. 14A shows an exploded view of an embodiment provided with the adjustment means in accordance with FIGS. 13A-C. As seen, the embodiment in FIG. 14A is provided with a buffer tank 618 which comprises a channel 620 and an aperture 622. The channel 620 connects the second inlet 118 and the outlet 206.

FIG. 14B illustrates that the T-shaped button 600 is arranged to insert to the aperture 622 of the buffer tank 618, and further illustrates the position of gaskets 122 and 124, in which a gasket 124, also called as a top cover ring, is arranged internally around the circumference of the lid cover 106.

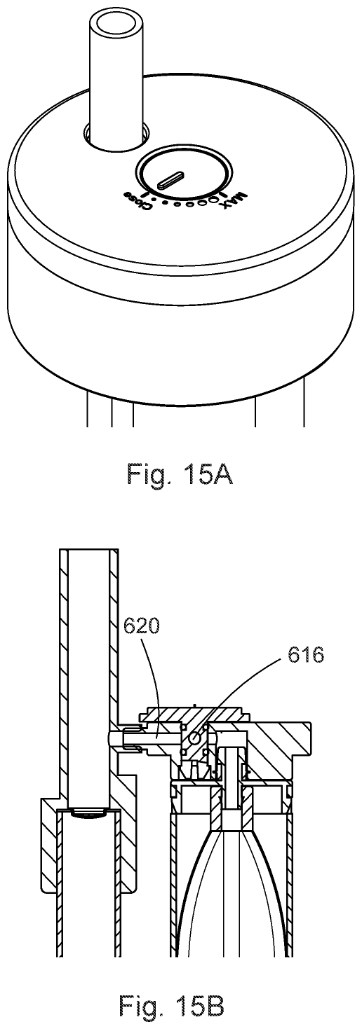

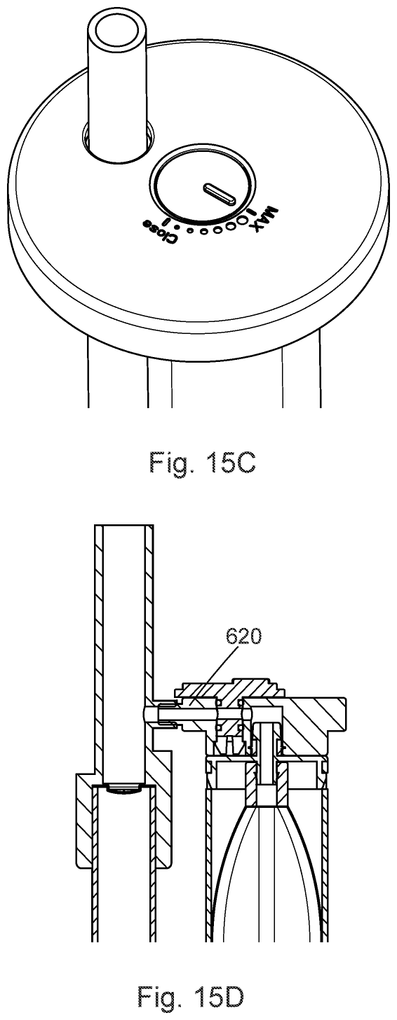

FIGS. 15A-C are schematic illustrations showing the state of the channel 620 of the buffer tank 618 when the T-shaped button 600 is in use, in particular in rotation. FIG. 15A shows that the T-shaped button 600 is configured to partially exposed over the lid cover 106, such that users can rotate the T-shaped button 600 to control the orientation of the through-opening 616 in result to control the internal tubular cavity of the channel 620. FIG. 15B corresponds to the T-shaped button 600 at “close” state illustrated in FIG. 15A, whereas FIG. 15C corresponds to the T-shaped button 600 at “max” state illustrated in FIG. 15A. It can be envisaged that when the T-shaped button 600 is at “close state”, the channel 620 is blocked as illustrated in FIG. 15B, thus juice is not allowed to be delivered to utility portion 108 even the venturi effect takes place. By gradually rotating the T-shaped button 600, say, gradually from 0 degree to 90 degrees anti-clockwise, the through-opening 616 also gradually from 0 degree to 90 degrees anti-clockwise, whereby the channel 620 is gradually opened, compared with the state in FIG. 15B, during the rotation of the T-shaped button 600. When the T-shaped button 600 is undergoing the rotating motion, the internal tubular cavity of the channel 620 is gradually increased along with the rotating motion beginning gradually from 0 degree to 90 degree.

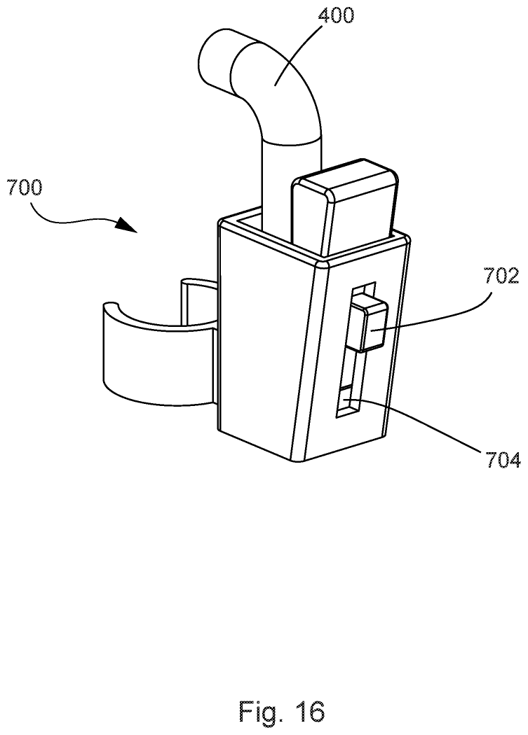

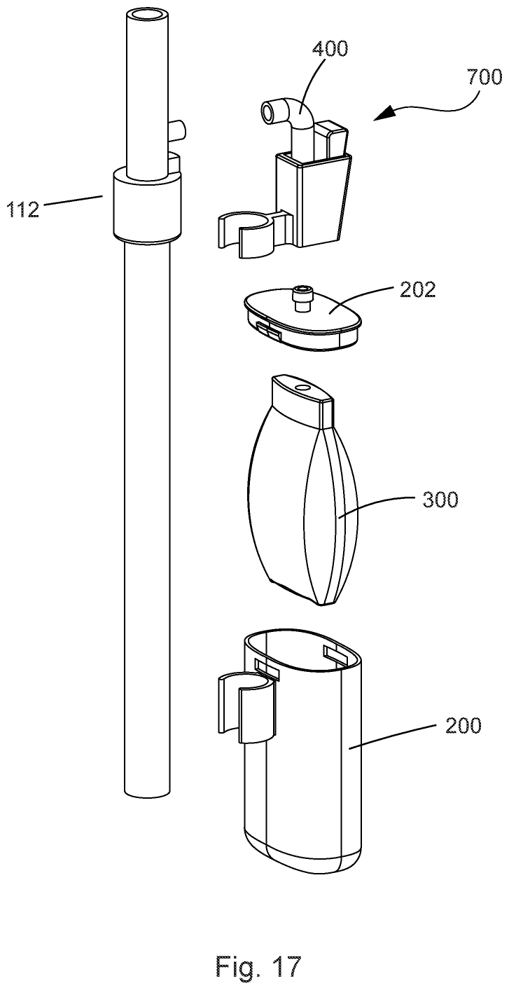

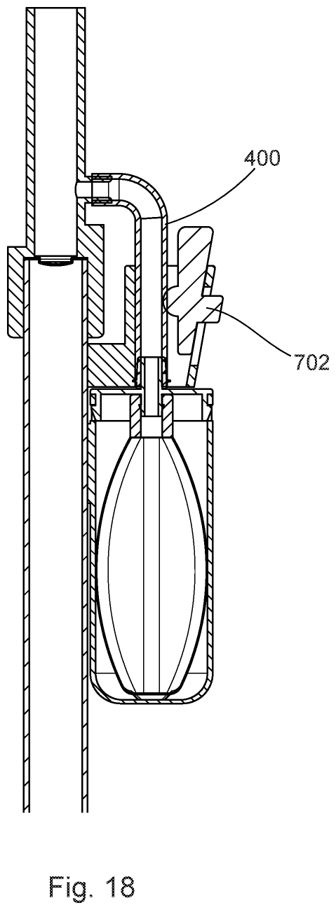

In one embodiment, FIGS. 16-17 shows that the adjustment means 500 is a wedge-shaped member 700 being arranged adjacent the tube 400, in particular longitudinally arranged with respect to the elongate profile of the drinking member 112. The wedge-shaped member 700 is provided with a handle 702 and a slot 704 being slanted corresponding to the slant profile of the wedge-shaped member 700. FIG. 18 shows a sectional view of the liquid dispensing apparatus of the present invention provided with the adjustment means 500 is in a form of the wedge-shaped member 700. Referring to FIGS. 16 and 18, it shall be understood that by sliding the handle 702 downwards in the slot 704, the handle 702 starts to press against the tube 400 (in this embodiment, the tube 400 is arranged vertically connecting the second inlet 118 and outlet 206), whereby the diameter of the tube is decreased and thus during the venturi effect the volume of fruit juice flowing towards the utility portion 108 is reduced. It shall be understood that as the handle 702 goes further downwards, the internal tubular cavity of the tube 400 reduces further. It shall also be understood that the wedge-shaped member 700 can be arranged in any position as long as it effects the tube 400, as described below.

In one embodiment, the adjustment means 500 is a tuning knob or rotating knob having an eccentric cylindrical profile being arranged adjacent, in particular on, the tube 400. By turning/rotating the knob about its rotational axis, the cylindrical profile of the knob squeezes/compresses the tube 400 and thus the diameter of the tube is decreased. Accordingly, during the venturi effect, the volume of fruit juice flowing towards the utility portion 108 is reduced. Since the knob has an eccentric cylindrical profile, therefore it can be envisaged that the edge farthest away from the rotational axis imposes greatest pressure on the tube 400, i.e., the internal tubular volume of the tube becomes least. In contrast, the edge closest to the rotational axis imposes least pressure on the tube 400, i.e., the internal tubular volume of the tube becomes largest. Yet another embodiment, the adjustment means 500 can be configured to entirely seize/grasp the tubing 400 and thus no fruit juice is allowed to pass through the tube 400 to arrive utility portion 108 even though there is venturi effect. In this embodiment, only water is consumed by users.

It shall be understood that embodiments above for the adjustment means 500 are examples only. Mechanical structures other than the description above that can adjust the flow of the second liquid from the second container also fall into the gist of the present invention. In other words, the operation of the adjustment means 500 is not limited by reducing the internal tubular cavity of the tube 400 only.

The liquid dispensing apparatus allows users to choose drinking the first liquid or a mixing between the first and second liquids according to their need. More specifically, the liquid dispensing apparatus allows users to adjust the concentration of the first liquid to be mixed and the second liquid to be mixed for mixing.

It shall be understood that the liquid dispensing apparatus according to the invention can be manufactured integrally with the lid member in a manufacturing purpose.

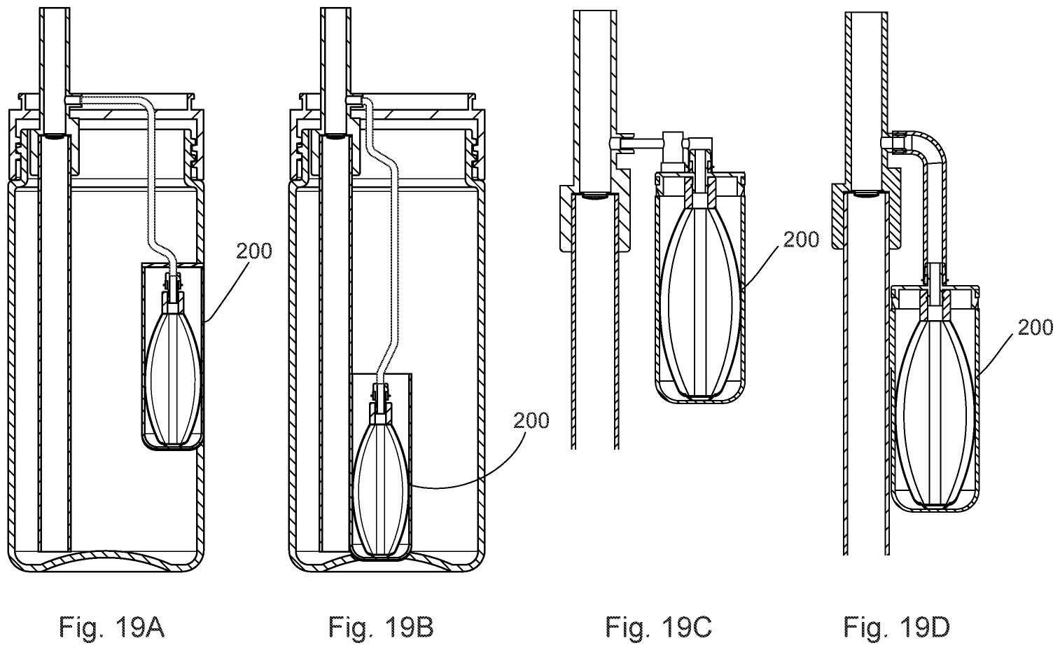

FIG. 19A-B show variants of embodiments of the bottle 100 configured with different position of the receptacle 114. Although the position of the second container 200 in FIGS. 19A-B is different, these embodiments still work with the description above, without departing the spirit of the invention. It can be envisaged that in the embodiment of FIG. 19A, part of the circumferential wall of the base member 102 can be opened to allow users to place or take out the juice pack. It can also be envisaged that in the embodiment of FIG. 19B, part of the bottom of the base member 102 can be opened to allow users to place or take out the juice pack. With reference to FIGS. 19A-B, it shall be understood that the utility portion of the present invention can be configured as part of the lid assembly assembled to the bottle.

However, it shall also be understood that the liquid dispensing apparatus according to the invention can also be manufactured independently without necessary with the lid member and be used stand alone, providing convenience to users to use the liquid dispensing apparatus according to the invention in different bottles, containers like mugs and glasses. Embodiments in FIGS. 19C-D, without the lid member 104, can be used to practice the invention according to the present application. The lid member 104 described herein shall not be construed as limitation to the invention of this application.

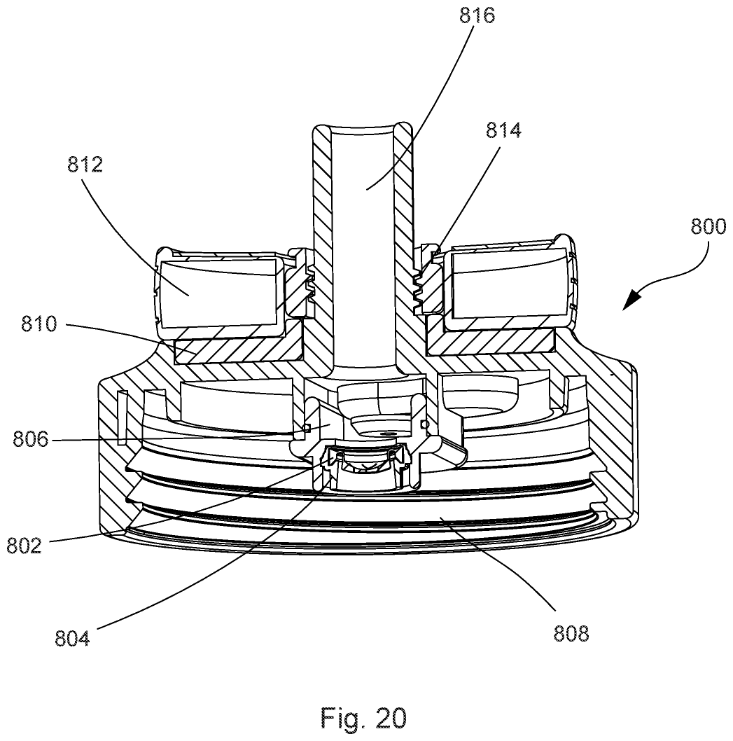

FIG. 20 is a perspective sectional view showing another embodiment of the liquid dispensing apparatus of the present invention. The utility portion of the liquid dispensing apparatus is part of a lid assembly 800. The lid assembly 800 comprises pressure valve 802, valve mounting member 804, mixing member 806, lid member 808, adjustment member 810, second container 812, ring member 814, and outlet 816.

In one embodiment, silicone rubber, in particular elastic silicone rubber, is suitable for preparing the valve 802 or the valve mounting member 804 or the mixing member 806.

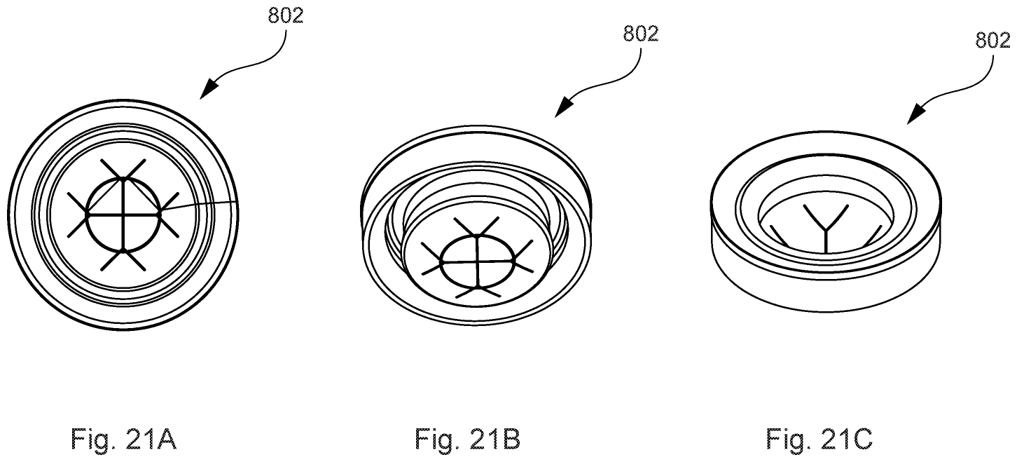

FIG. 21A-C shows the pressure valve 802 with different views, in which FIG. 21A is a top view, FIG. 21B is a perspective bottom view, and FIG. 21C is a bottom view. Similar to the valve 120 as described above, the pressure valve 802 is characterized with a valve in is in cruciform at opening pressure at 5 kPa. Therefore, operation of the pressure valve 802 refers to the operation of the valve 120, as above.

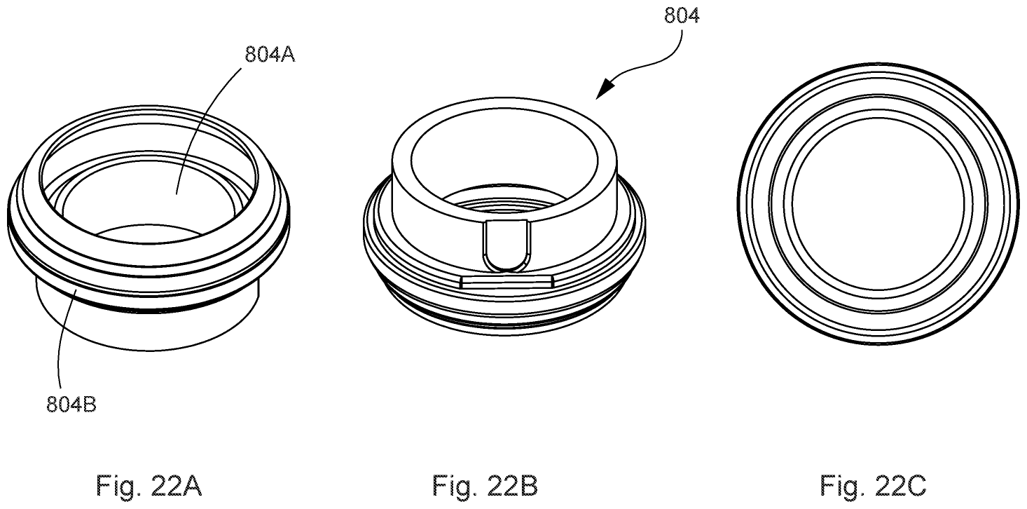

FIG. 22A-C shows the valve mounting member 804 with different views, in which FIG. 22A is a perspective top view, FIG. 22B is a perspective bottom view, and FIG. 22C is a bottom view. The internal cavity in a form of central aperture 804A of the upper portion of the valve mounting member 804 is dimensioned and designed to accommodate the pressure valve 802 to sit therein, as shown in FIG. 20.

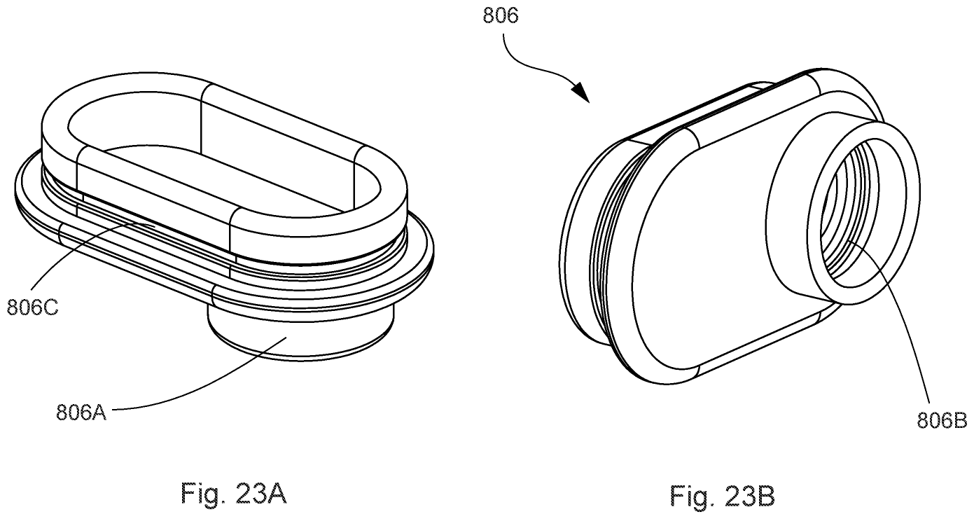

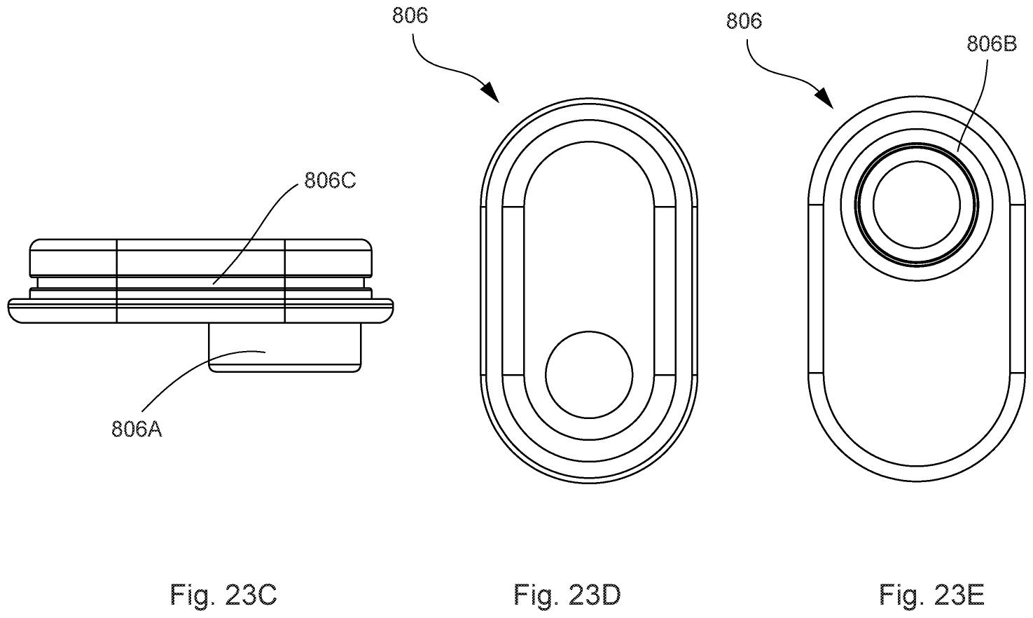

FIG. 23A-E shows the mixing member 806 with different views, in which FIG. 23A is a perspective top view, FIG. 23B is a perspective bottom view, FIG. 23C is a side view, FIG. 23D is a top view, and FIG. 23E is a bottom view. The mixing member 806 has an upper portion dimensioned to provide a cavity, and a lower portion configured to provide a receptacle 806A. The receptacle 806A is dimensioned and designed to accommodate the valve mounting member 804 with the pressure valve 802, as shown in FIG. 20. For example, internal of the receptacle 806A is provided with a first engaging member 806B. By engaging the engaging member 804B (in FIG. 22A) of the valve mounting member 804 with the first engaging member 806B of the mixing member 806, for example press fitting, the valve mounting member 804 is removably secured in the receptacle 806A, as shown in FIG. 20.

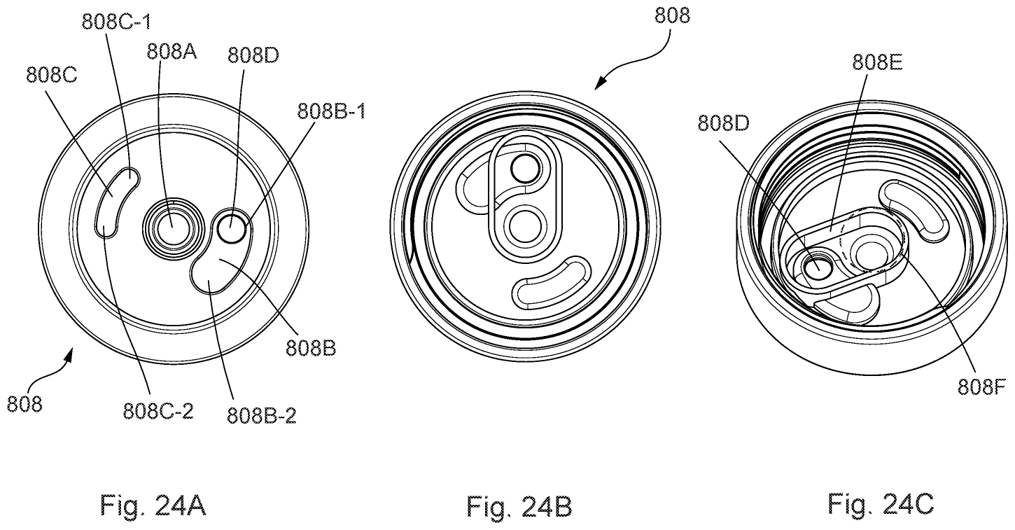

FIG. 24A-C shows the lid member 808 with different views, in which FIG. 24A is a top view, FIG. 24B is a bottom view, FIG. 24C is a perspective bottom view. As shown in FIG. 24A, the lid member 808 is provided with a central aperture 808A for removably receiving the outlet 816, a first groove 808B and a second groove 808C. The grooves 808B and 808C are arranged oppositely facing to each other, and are in sickle-like shape. The first groove 808B has a first end 808B-1 and a second end 808B-2. The second groove 808C has a first end 808C-1 and a second end 808C-2. At the first end 808B-1, there is provided with an aperture 808D, which is the second inlet of the utility portion of the present invention. FIG. 24C shows that the internal cavity of the lid member 808 is provided with a recess 808E. It is important to note that a portion of the recess 808E, underneath the central aperture 808A, is a first inlet 808F of the utility portion of the present invention. For clarity's sake, please see the dotted circle part in FIG. 24C as the first inlet 808F. Those skilled in the art shall understand that the position and the shape of the grooves 808B and 808C and the aperture 808D in FIG. 24 are illustrative examples only, and shall not impose any limitation to the disclosed invention. In some embodiments, the outlet 816 and the lid member 808 are integrally formed.

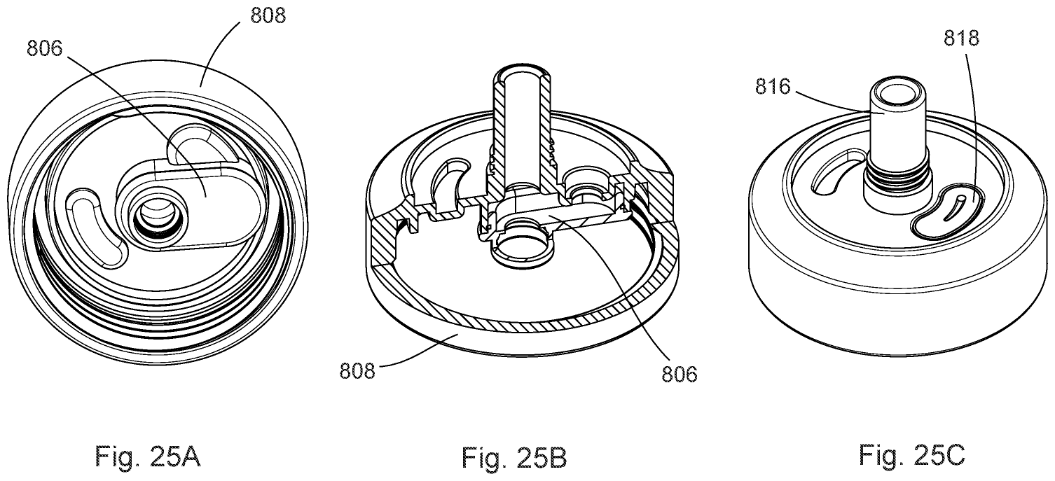

Referring to FIGS. 25A and 25B, it can be seen that the size and shape of the recess 808E is suitable to accommodate the mixing member 806, for example, by press-fitting the mixing member 806 in the recess 808E, whereby the second engaging member 806C of the mixing member 806 abuts against the wall of the recess 808E. FIG. 25C illustrates that a buffer tank 818, preferably made in silicone rubber, more preferably in elastic silicone rubber, sits in the first groove 808B.

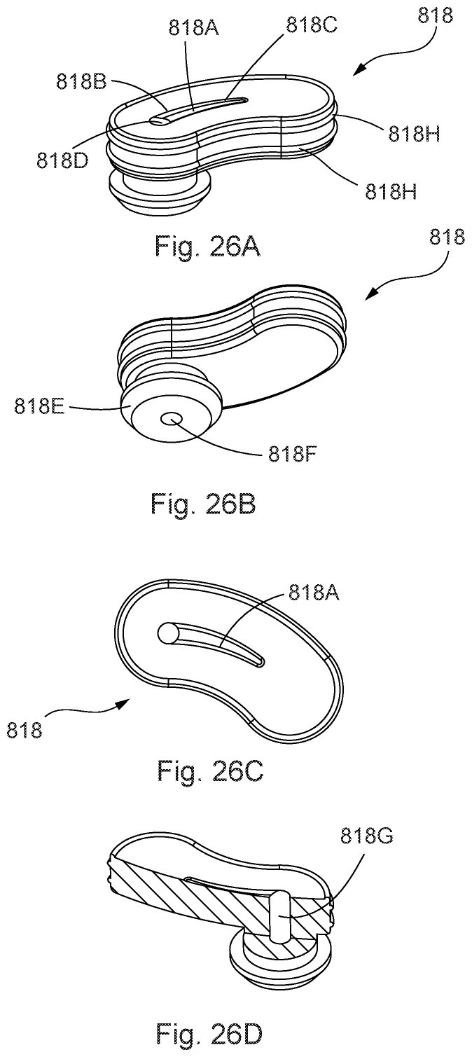

FIGS. 26A-D shows the buffer tank 818 with different views, in which FIG. 26A is a perspective top view, 26B is a perspective bottom view, 26C is a top view, and 26D is a sectional view.

FIG. 26A shows that the upper surface of the buffer tank 818 is provided with a groove 818A in a sickle-like profile having a first end 818B and a second end 818C, in which the width of the groove is designed to be narrowing from the first end 818B towards the second end 818C. A first opening 818D is provided at the first end 818B. In addition, it can be seen that the depth of the groove is designed to be decreasing from the first end 818B towards the second end 818C. Those skilled in the art shall understand that the profile of the groove 818A shown in FIG. 26 is an example only, and could be modified according to actual needs when the present invention is in use.

FIG. 26B shows that the buffer tank 818 is provided with a leg portion 818E where a second opening 818F is provided at the bottom thereof. The first opening 818D (at the first end 818B) and the second opening 818F define a channel 818G, as shown in FIG. 26D. It shall be understood that the channel 818G and the mixing member 806 are fluid communicable.

Referring to FIG. 24A, FIG. 25C, and FIG. 26B, it can be understood that the leg portion 818E of the buffer tank 818 is inserted into the aperture 808D of the lid member 808, thus the buffer tank 818 is removably secured and received in the first groove 808B of the lid member 808. Preferably, as illustrated in FIG. 26B, the leg portion 818E is provided an enlarged head having size slightly larger than that of the aperture 808D, such that for example by press fitting the enlarged head through the aperture 808D, it can prevent the buffer tank 818 from disengaging from the lid member 808 easily. Preferably, the buffer tank 818 is provided with engaging member 818H at its peripheral for facilitating the installation of the buffer tank 818 in the first groove 808B of the lid member 808.

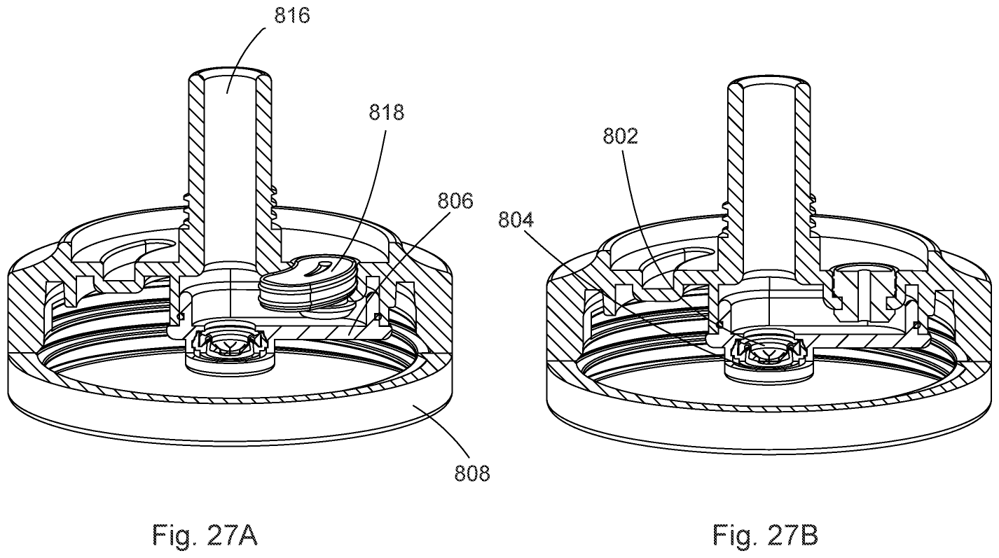

FIGS. 27A and 27B show the assembly between the pressure valve 802, the valve mounting member 804, the mixing member 806, the lid member 808, the outlet 816, and the buffer tank 818. These figures show that there is a gap between the leg portion 818E of the buffer tank 818 and the cavity of the mixing member 806. It shall be understood that the outlet 816, the mixing chamber 806, and the buffer tank 818 are fluid communicable.

It shall be understood that the assembly in FIG. 27 (also in FIG. 20) can be assembled to/on a base member, for example base member 102, where the first liquid (water) is contained. For brevity, FIG. 27 does not show the base member. It shall be understood that the base member, the pressure valve 802, the valve mounting member 804, the mixing member 806, the outlet 816 are fluid communicable. Where necessary, a straw, for example the straw 110 can be connected at the first inlet of the utility portion with commonly known means, as FIGS. 1-19 shown. In this embodiment, the straw with the utility portion defines a drinking member, as described above. With FIGS. 20-27, it shall be understood that the configuration of the main body of the utility portion, the mixing member 806, and the pressure valve 802 together defines a cavity. With the drinking member, the user sucks the first liquid (stored in the first container) passing through the pressure valve 802 upwards, the pressure in said cavity is reduced thus generating the venturi effect that happens adjacent the second opening 818F.

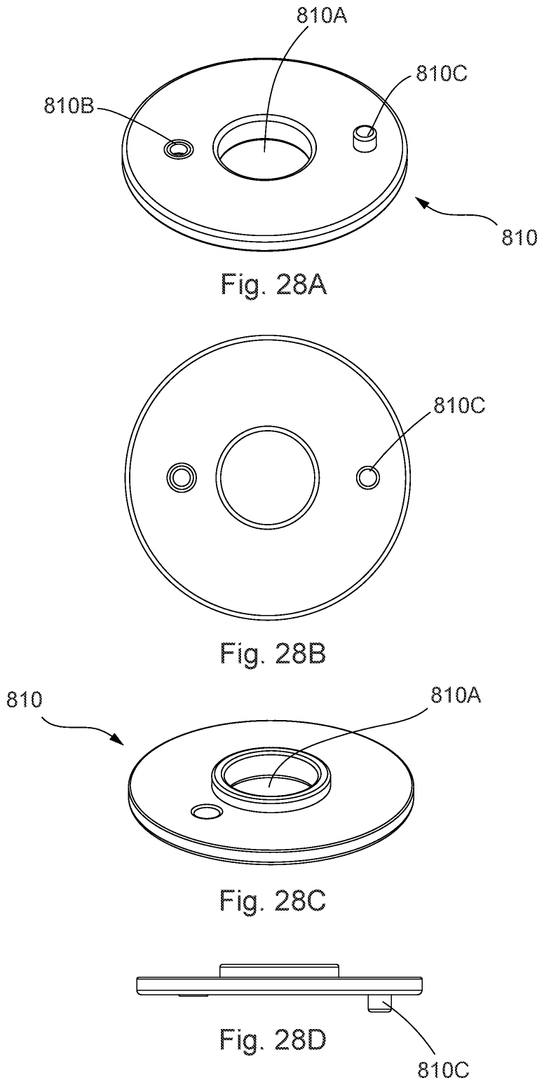

FIG. 28A-D shows the adjustment member 810 with different views, in which FIG. 28A is a perspective top view, FIG. 28B is a perspective bottom view, FIG. 28C is a top view, and FIG. 28D is a side view. The adjustment member 810 is provided with a first aperture 810A located at the central, a second aperture 810B, and a protrusion 810C. The position of the aperture 810B and the protrusion 810C are arranged oppositely facing with each other. It shall be understood that the position, number, and shape of the aperture 810B and the protrusion 810C are examples only.

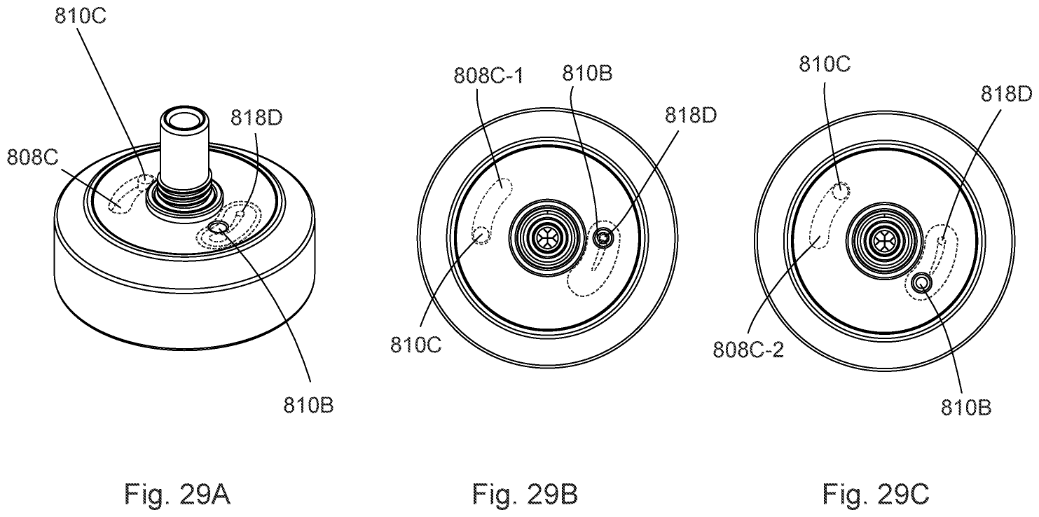

FIGS. 29A-C show the assembling of the adjustment member 810 on the lid member 808. For better illustration, components such as the buffer tank 818, the second groove 808C of the lid member 808, the protrusion 810C of the adjustment member 810 that should be out of sight in FIGS. 29A-C are now illustrated in dotted lines. As shown, the protrusion 810C is arranged in the second groove 808C of the lid member 808, and the second aperture 810B is arranged over the buffer tank 818.

Specifically, FIG. 29A shows that the adjustment member 810 is assembled to the lid member 808 by passing the first aperture 810A through the outlet 816, in which the protrusion 810C is received in the second groove 808C of the lid member 808, and the second aperture 810B is positioned over the buffer tank 818 which is assembled to the first groove 808B of the lid member 808.

With FIGS. 29B-C, it shall be understood that the adjustment member 810, after assembling to the lid member 808, is configured to circularly rotate about the outlet 816 in certain extent or range which is limited by the allowed motion of the protrusion 810C of the adjustment member 810 in the second groove 808C. In other words, said extent or range is limited by the length of the second groove 808C. In FIG. 29B, it can be seen that when the protrusion 810C of the adjustment member 810 is moved to the second end 808C-2 of the lid member 808, the second aperture 810B is then superimposed over the first opening 818D of the buffer tank 818. Both the second aperture 810B and the first opening 818D are exposed in FIG. 29B.

Still referring to FIGS. 29B-C, when the adjustment member 810 moves circularly about the outlet 816 in a state in FIG. 29B in a clockwise direction about the outlet 816 to another state in FIG. 29C, it can be seen that the protrusion 810C is now at the first end 808C-1 of the lid member 808 and the second aperture 810B is now at the second end 818C of the buffer tank 818. In other words, the first opening 818D of the buffer tank 818 is out of sight and is covered by the adjustment member 810 (the appearance of the first opening 818D in FIG. 29C is for illustration only).

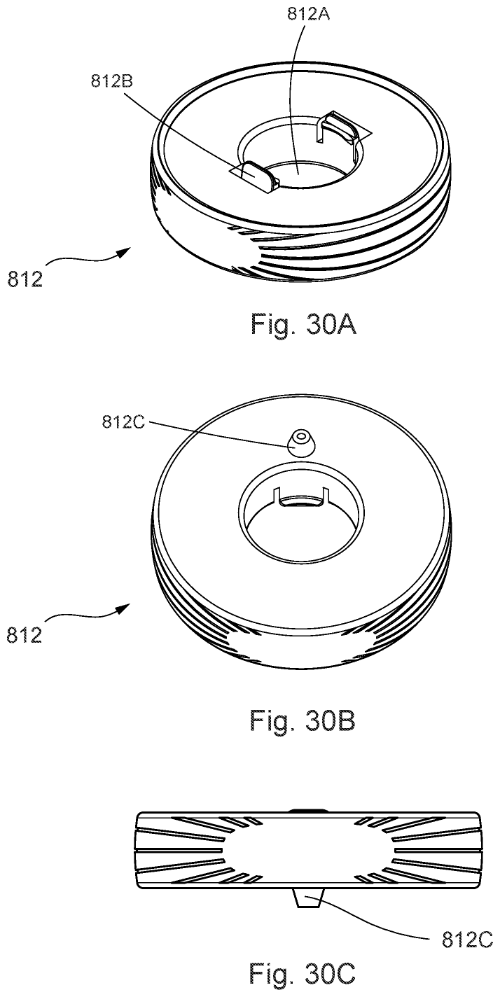

FIG. 30A-C shows the second container 812 with different views, in which FIG. 30A is a perspective top view, FIG. 30B is a perspective bottom view, and FIG. 30C is a side view.

Selectively, the second container is disposable. The second container is provided with a central aperture 812A, a pair of engaging members 812B at the perimeter of the central aperture 812A. As shown, the pair of engaging members 812B are arranged oppositely facing with each other. The bottom side of the second container is provided with a protrusion 812C having an opening allowing the second liquid (fruit juice) flowing out. Similar to the second container 200 as described above, description on the second container 812 refers to the description of the second container 200.

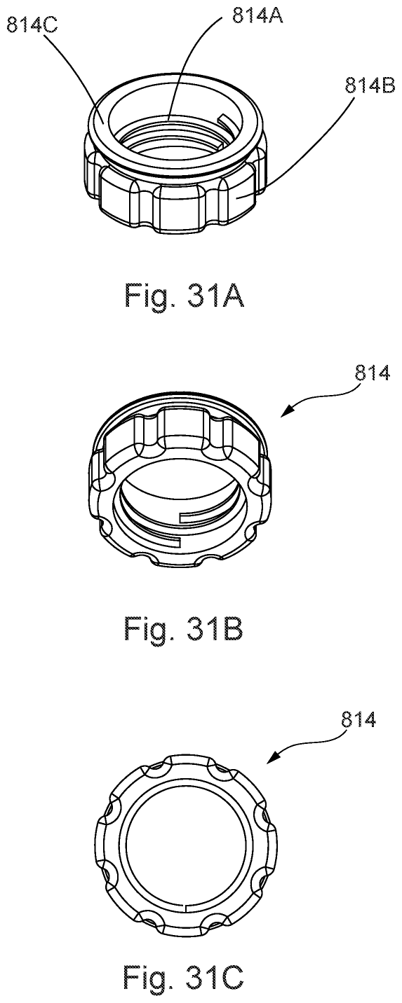

FIG. 31A-C shows the ring member 814 with different views, in which FIG. 31A is a perspective top view, FIG. 31B is a perspective bottom view, and FIG. 31C is a top view.

The ring member 814 is provided with a central aperture 814A allowing the outlet 816 passing therethrough. The peripheral of the ring member 814 is provided with gripping member 814B providing ease to users to rotate the ring member 814 about the outlet 816 for mounting or dismounting the ring member 814 to the outlet 816.

The internal perimeter of the ring member 814 is provided with threads or threading member, which couples with the threads or threading member on the outlet 816 (see: FIGS. 20, 25, and 27). By means of these threads or threading members between the ring member 814 and the outlet 816, when the ring member 814 is mounted to the outlet 816 with the central aperture 814A passing through the outlet 816, the ring member 814 can be configured to screw upwards by screwing in one direction and can be configured to screw downwards by screwing in another direction, whereby the ring member 814 can be secured in position about the outlet 816.

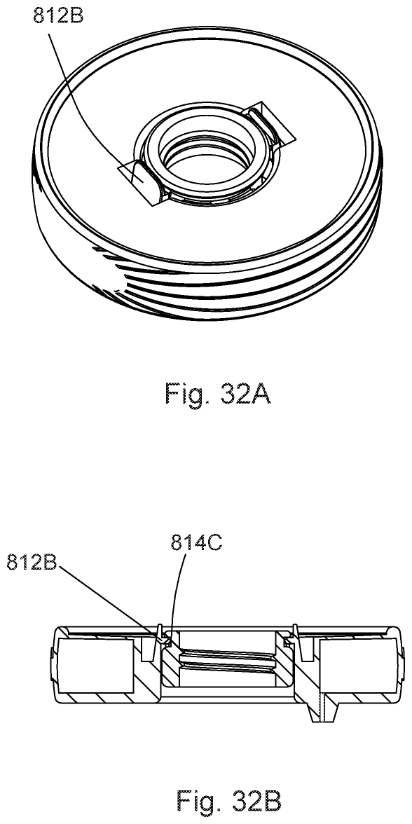

FIG. 32A is a perspective view of the assembly between the ring member 814 and the second container 812, and FIG. 32B is a sectional view of the assembly between the ring member 814 and the second container 812. FIG. 32 shows the assembly between the ring member 814 and the second container 812 by a snapping between the pair of engaging members 812B of the second container 812 and the engaging member 814C of the ring member 814. It can be seen that there is separation between the peripheral wall of the ring member 814 and the inner wall of the second container 812, thus the second container can be configured to rotate about the ring member 814 while the ring member 814 remains secured. In other words, the second container 812 can be configured to move independently of the ring member 814.

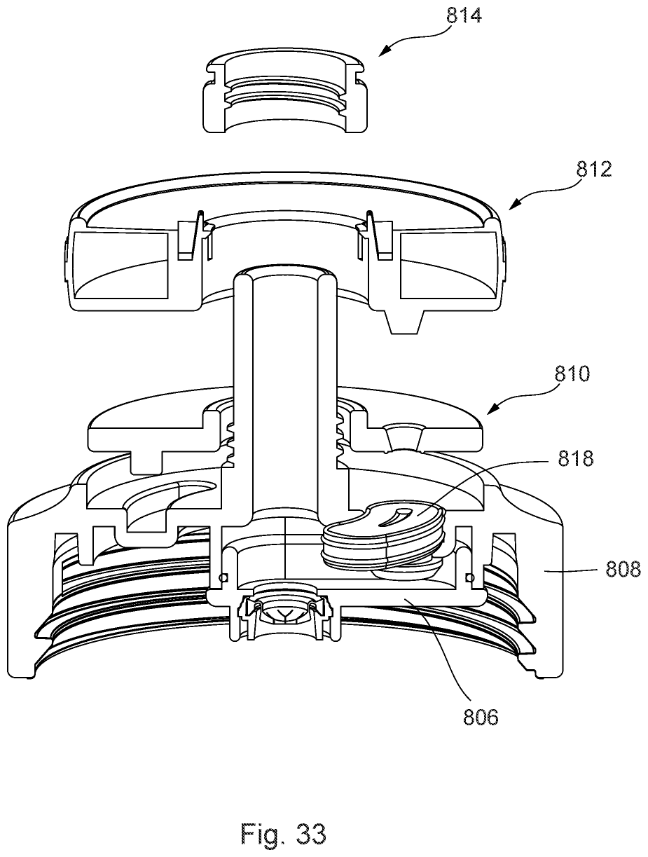

FIG. 33 shows an exploded view of the lid assembly 800 comprising the mixing member 806, the lid member 808, the adjustment member 810, the second container 812, the ring member 814, the outlet 816, and the buffer tank 818. Concerning the assembling of the mixing member 806, the lid member 808, the adjustment member 810, the outlet 816, and the buffer tank 818, please refer to the foregoing description above.

Concerning the assembling of the second container 812 with the ring member 814 (the two illustrations in FIG. 32) about the outlet 816, it is realized by first positioning the protrusion 812C of the second container 812 over the second aperture 810B of the adjustment member 810. Then, the second container 812 with the ring member 814 (the illustration in FIG. 32) is screwed for example downwards about the outlet 816 with the aid of the respective threads or threading members provided on the ring member 814 and the outlet 816, as described above.

Preferably, one embodiment has a first configuration that is defined by the opening at the protrusion 812C of the second container 812 over the first opening 818D of the buffer tank 818, whereby the volumetric flow for the fruit juice is at maximum, from the second container 812 to the first opening 818D of the buffer tank 818, since the opening at the protrusion 812C of the second container coincides with the first opening 818D of the buffer tank 818 thus maximizing the volume flow therebetween. Said embodiment has a second configuration that is defined by the opening at the protrusion 812C of the second container 812 over the second end 818C of the buffer tank 818, whereby the volumetric flow for the fruit juice is the least, from the second container 812 to the buffer tank 818, since the opening at the protrusion 812C of the second container is abutted against by the second end 818C of the buffer tank 818. More preferably, the second configuration can be configured to essentially seal the opening at the protrusion 812C of the second container by the second end 818C of the buffer tank 818, whereby there is essentially no fruit juice from the second container 812 to the buffer tank 818.

When the lid assembly 800 is in use, a user can connect the utility portion with a straw together, defining a drinking member (as described above) and assemble the lid assembly 800 (with the straw) to a bottle (first container) where water is stored. When a user sucks the water in the bottle (not shown in figure) with the drinking member, which is for example provided with the valve 802 as described above, when the pressure-drop inside utility portion starts to exceed 5 kPa, the water in the container starts being drawn fast and upwards by the straw of the drinking member (not shown in figure) towards the outlet 816. Such fast upwards movement of the water through the utility portion 108 leads to a venturi effect at the second inlet of the utility portion 806 and thus the pressure at the second inlet of the utility portion is reduced.

Due to venturi effect, the fruit juice in the second container 812 is then drawn downwards leaving the second container 812 through the opening at the protrusion 812C, then through the second aperture 810B of the adjustment member 810, to the buffer tank 818 via the first opening 818D, then the fruit juice flows to the mixing chamber 806 out of the buffer tank 818 via the channel 818G defined by the first opening 818D (at the second end 818C) and the second opening 818F of the buffer tank 818. In the mixing chamber 806, the fruit juice mixes with the water being drawn by the user. Accordingly, the mixture between the water and the fruit juice is transported to the outlet 816 and is then consumed by the user.

The lid assembly 800 can also be used without using a straw connected to the outlet 816. In this way, when the lid assembly 800 is assembled to the first container, it works like a baby bottle when lid assembly 800 is in use. In other words, when the lid assembly 800 works in this way, the lid assembly 800 shown in FIGS. 20 and 33 is upside down.

The lid assembly 800 is also provided with an adjustment means for adjusting the concentration of the first liquid to be mixed and the second liquid to be mixed for mixing. The adjustment means can be at least realized by using the adjustment member 810 in collaborative operation with the buffer tank 818.

With the contents described above, in particular concerning the FIGS. 26-29, one skilled in the art could understand that the mixing between the water and the fruit juice in the mixing chamber depends on the amount of fruit juice flowing into the mixing chamber when the venturi effect is happening.

It could be understood that in a first situation, when the position of the opening at the protrusion 812C of the second container 812 is right over the first opening 818D (at the first end 818B) of the buffer tank 818, the fluid path (defined by the opening at the protrusion 812C of the second container 812 and the channel 818G of the buffer tank 818) is fully established or enabled. In the first situation, the fruit juice flowing into the mixing chamber 806 is at its maximum when the venturi effect takes place. It could also be understood that in a second situation, when the position of the opening at the protrusion 812C of the second container 812 is right over the second end 818C of the buffer tank 818, the fluid path (defined by the opening at the protrusion 812C of the second container 812 and the channel 818G of the buffer tank 818) is obstructed or disabled. In the second situation, the fruit juice flowing into the mixing chamber 806 is the least when the venturi effect takes place. In the second situation, for some embodiments, the fruit juice flowing into the mixing chamber 806 is null when the venturi effect takes place, depending on the design of the lid assembly 800.

Specifically, taking the illustrations in FIGS. 29B-C as an example, the fluid path in FIG. 29B is fully established or enabled. In contrast, the fluid path in FIG. 29C is obstructed or disabled.

With description above, it shall be understood that the user can selectively adjust the amount of the fruit juice flows into the mixing chamber 806 for mixing therein, by rotating the second container 812 or the adjustment member 810 or both circularly about the outlet 816 in a clockwise direction or an anticlockwise direction, depending on the actual design of the lid assembly 800.

With contents described above, it shall be understood that the liquid dispensing apparatus according to the invention comprises the utility portion, in fluidic communication with a first liquid contained in the base member (a first container); a second container, where a second liquid is stored, is in fluidic communication with the utility portion. Operation of the liquid dispensing apparatus refers to the contents described above.

Those skilled in the art should understand that the disclosed adjustment or the adjustment mechanism are examples only and shall not be construed as a limitation to the gist of the invention. As long as the user can adjust the amount of juice flowing out from the second container for mixing with the first liquid during the venturi effect, it falls within the gist of the present invention. In particular, as long as the user can adjust the fluid communication between the first container and the second container by an adjustment mechanism, in particular during the venturi effect, it falls within the gist of the present invention.

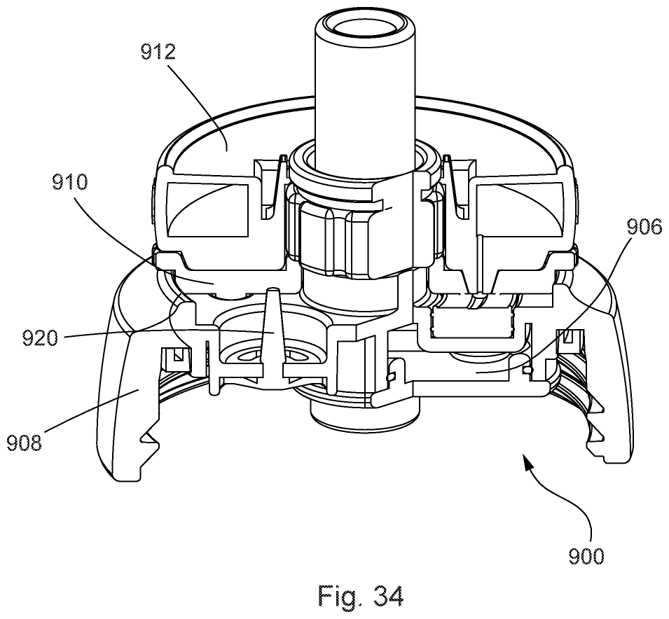

FIG. 34 is a perspective sectional view of a lid assembly 900, which is a variant of the lid assembly 800. Contexts below only describes the differences between the lid assemblies 800 and 900.

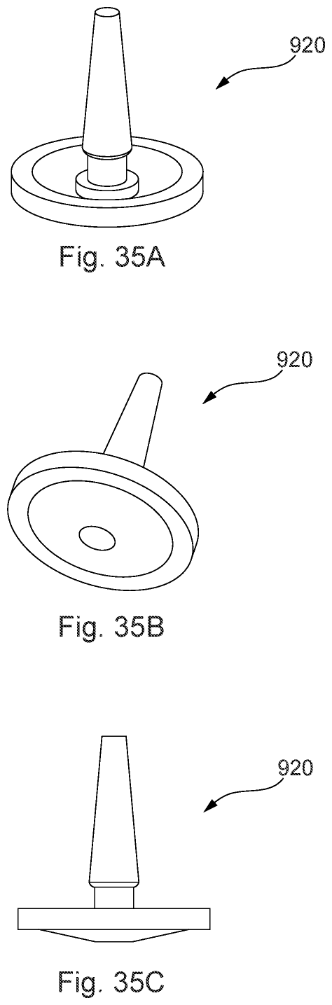

FIG. 35 shows the gas vent 920 with different view, in which FIG. 35A is a perspective top view, FIG. 35B is a perspective bottom view, and FIG. 35C is a side view. Selectively, the gas vent 920 is an umbrella valve having a diaphragm shaped sealing disk allowing one-way flow while preventing backflow. Such gas vents are commonly known in the art and thus contents herein do not describe it in details.

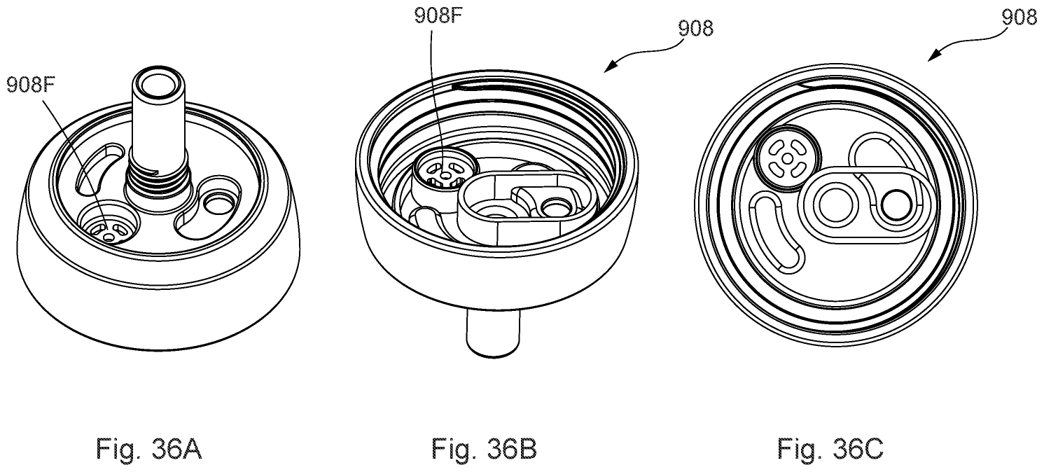

FIG. 36 shows the lid member 908 with different views, which is a variant of the lid member 808. FIG. 36A is a perspective top view, FIG. 36B is a perspective bottom view, and FIG. 36C is a bottom view. It differs from the lid member 808 by a recess 908F for accommodating the gas vent 920.

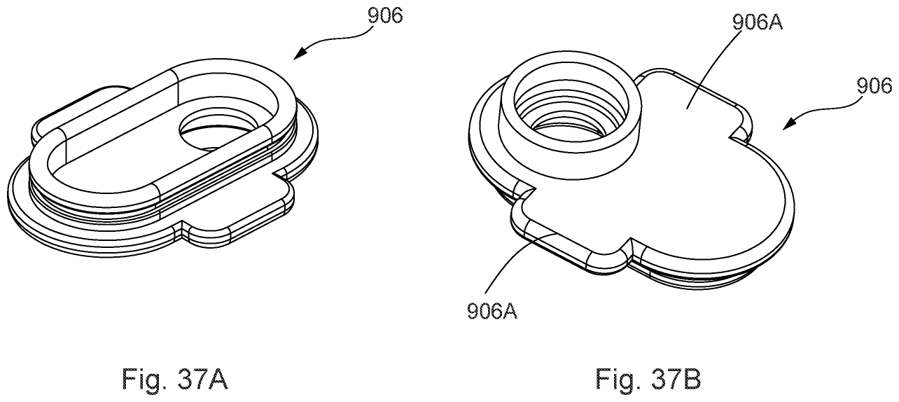

FIG. 37 shows the mixing chamber 906 with different view, in which FIG. 37A is a perspective top view, FIG. 37B is a perspective bottom view. The mixing chamber 906 is provided with a pair of wings 906A for providing ease to users to dismount of the mixing chamber 906 from the lid member 908.

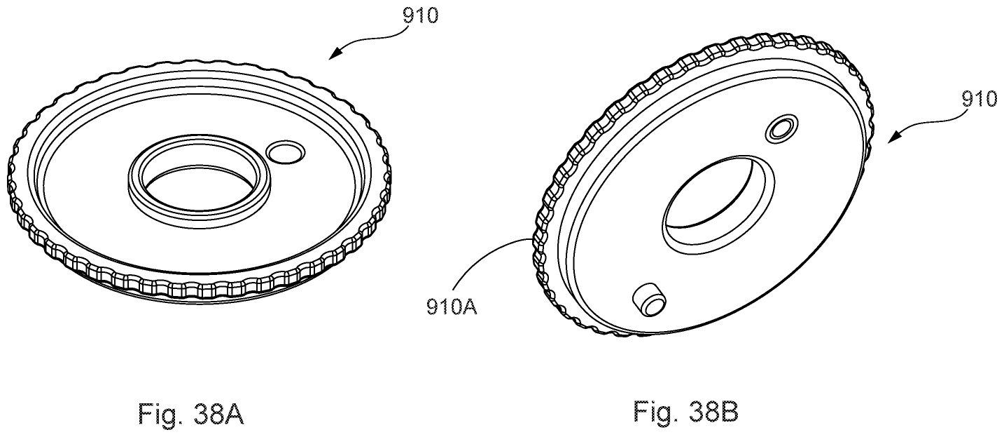

FIG. 38 shows the adjustment member 910 with different views, which is a variant of the adjustment member 810. FIG. 38A is a perspective top view, FIG. 38B is a perspective bottom view. Referring to FIGS. 34 and 38, it can be seen that the adjustment member 910 after assembling to the lid member 908, the perimeter of the adjustment member 910 is outwardly exposed. The serpent-like perimeter 910A of the adjustment member 910 provides ease to users to rotate the adjustment member 910 about the spout.

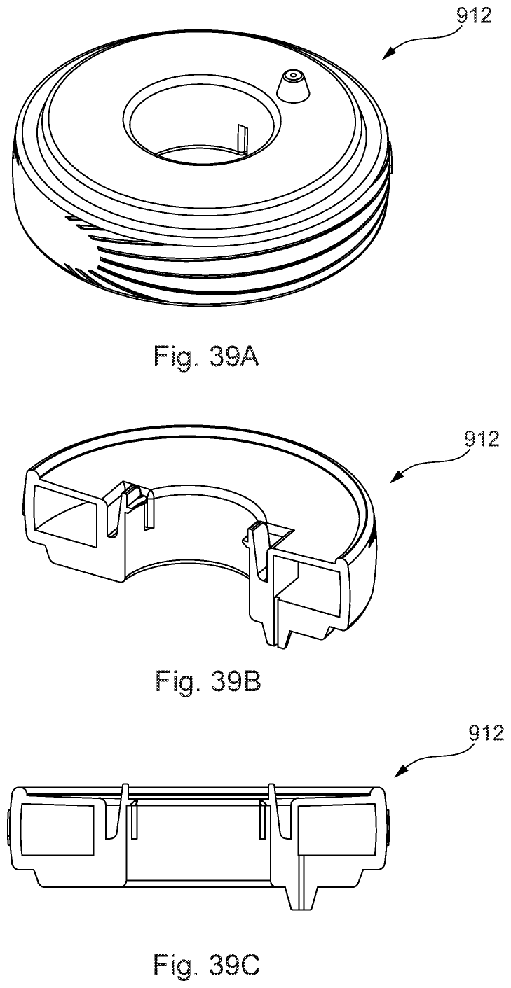

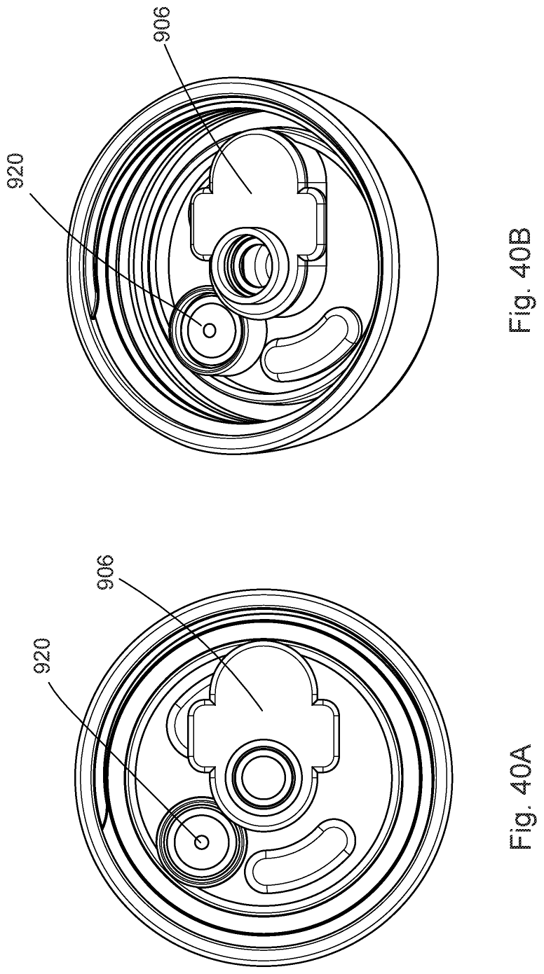

FIG. 39 shows the second container 912 with different views, which is a variant of the second container member 812. FIG. 39A is a perspective top view, FIG. 39B is a perspective sectional view, and FIG. 39C is a sectional side view. FIG. 40 shows the assembling of the gas vent 920 and the mixing chamber 906 to the lid member 908, in which FIG. 40A is a bottom view and FIG. 40B is a perspective bottom view.

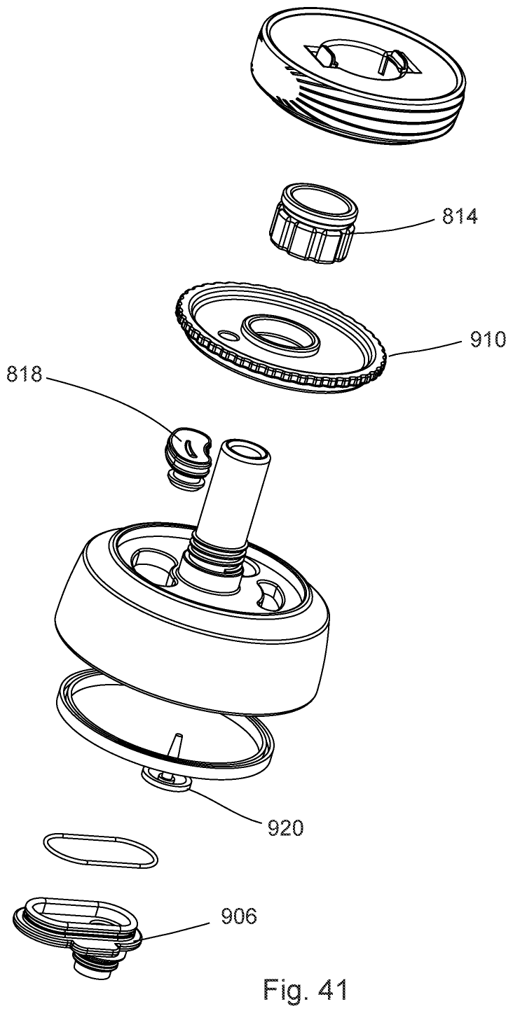

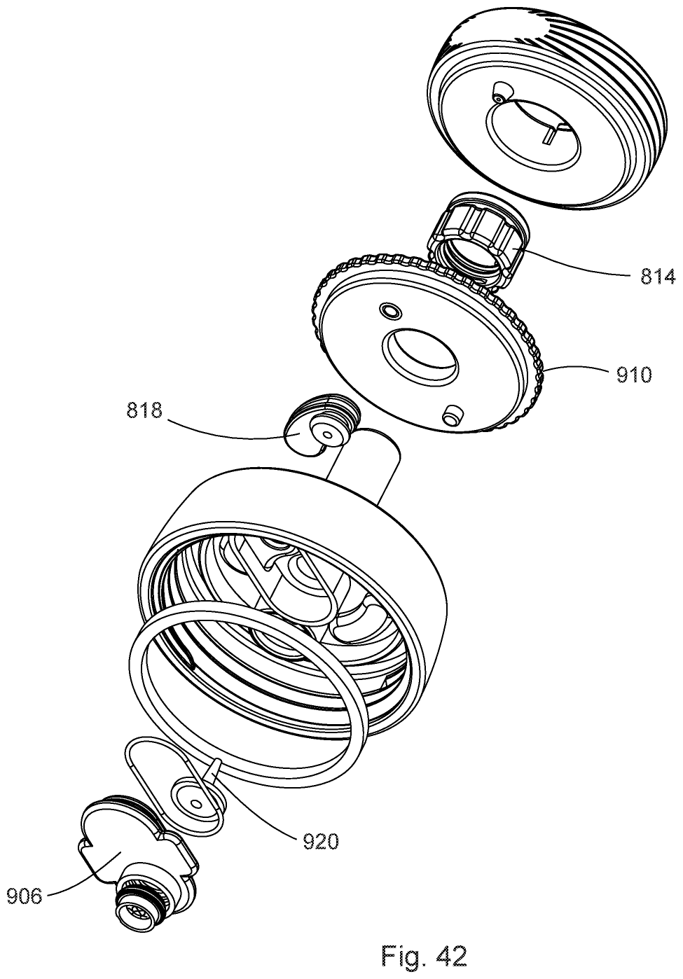

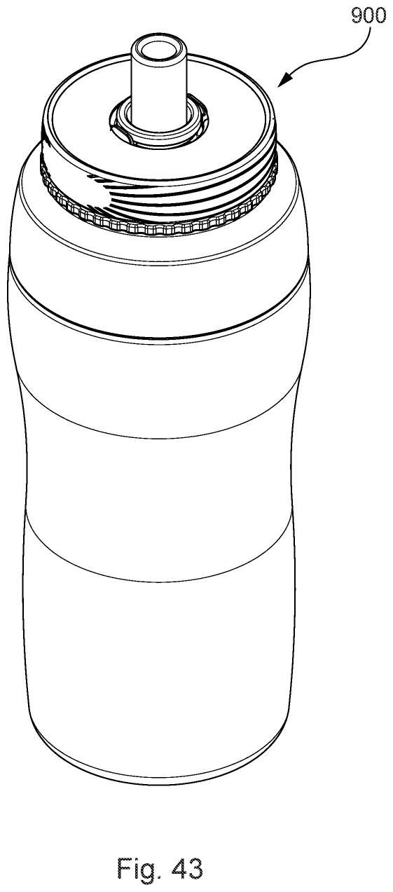

FIG. 41 is an exploded illustration of the lid assembly 900, in a perspective top view. FIG. 42 is an exploded illustration of the lid assembly 900, in a perspective bottom view. FIG. 43 is an assembling of the lid assembly 900 to a base member, resulting in a bottle according to the present invention.

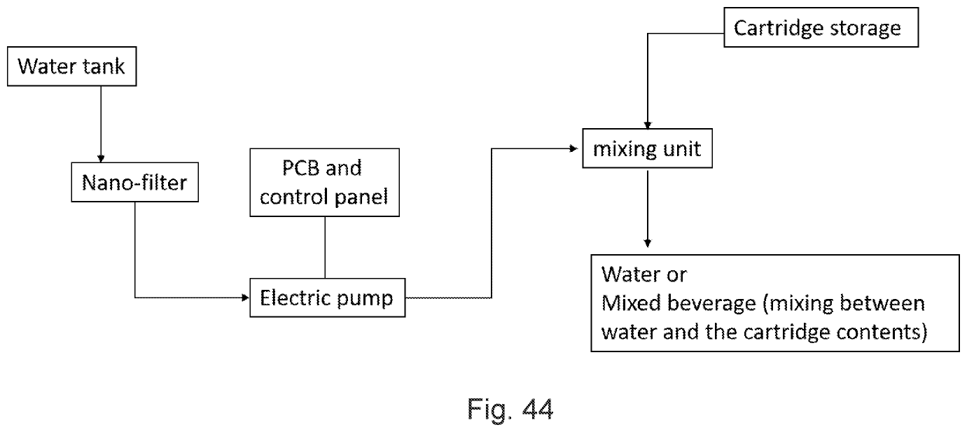

FIG. 44 is a schematic drawing showing the operation of a beverage dispenser, which is provided with the liquid dispensing apparatus according to the present invention. The beverage dispenser is designed to cater to a wide range of beverage preferences. Specifically, it allows users the flexibility to choose between consuming a standalone first liquid or opting for a mixture of the first liquid and a second liquid, based on their individual needs and desires. Moreover, the beverage dispenser enables users to precisely adjust the concentration of both the first and second liquids to be mixed together.

The beverage dispenser in this embodiment comprises several essential components, including a main body having a dispenser outlet, a water tank (serving as the first container for the first liquid), a nano-filter, an electric pump, and a cartridge storage (serving as the second container for the second liquid), and the liquid dispensing apparatus according to the present invention. These components are intelligently interconnected, both electrically and fluidically, to ensure seamless operation, as illustrated in FIG. 44. Importantly, the beverage dispenser is equipped with a control panel. Preferably, the cartridge storage is disposable or replaceable, providing advantage to prohibit bacteria growth in the beverage dispenser. Preferably, the tube connecting the electric pump and the water tank is also replaceable, serving the same advantage to prohibit bacteria growth in the beverage dispenser.

In some embodiments, the dispensing outlet is a specially designed nozzle, that allows for the discharge of both the first liquid and/or the second liquid while enabling desirable mixing. This means that users can conveniently select and enjoy their preferred combination of liquids, whether it's water, energy drinks, or other flavor options available in the dispenser, in particular the cartridge storage. Preferably, the nozzle is disposable or replaceable, providing advantage to prohibit bacteria growth in the beverage dispenser.

The water tank, as the primary container, holds the water supply for the dispenser. It ensures a steady source of clean and fresh water. To enhance the quality of the dispensed beverage, a nano-filter is integrated within the system. This specialized filter effectively removes impurities and contaminants, ensuring a purer and healthier drinking experience. Preferably, the nano-filter filters the water before entering the liquid dispensing apparatus.

The nano-filter, a crucial component of the beverage dispenser, is designed with advanced filtration capabilities to ensure the highest quality of the dispensed beverage. It incorporates nanofiber and/or activated carbon materials, which are preferably arranged in a rod-like configuration. This novel design maximizes the filtration efficiency and effectiveness of the nano-filter.

The primary function of the nano-filter is to eliminate various contaminants from the water or other liquids used in the dispenser. It is specifically engineered to meet stringent quality standards, such as the NSF42 requirement, by effectively removing chlorine, taste, and odor. This ensures that the dispensed beverage is not only free from unpleasant flavors and smells but also meets the desired taste expectations.

In addition to removing taste and odor, the nano-filter excels in eliminating heavy metals, meeting the NSF 53 requirement. Heavy metals, known for their potential harmful effects, are efficiently filtered out, safeguarding the health and well-being of the consumers. This feature is particularly beneficial for individuals concerned about the presence of contaminants in their drinking water or beverages.

Furthermore, the nano-filter demonstrates exceptional performance in eliminating bacteria and viruses, achieving a remarkable 99% removal rate. This high level of filtration ensures that the dispensed beverage is safe and free from harmful microorganisms, providing peace of mind to the users.

By combining the filtering capabilities of nanofiber and activated carbon materials, the nano-filter offers comprehensive purification of the liquid passing through it. It acts as a reliable barrier, capturing impurities and ensuring that only clean and high-quality water or liquid reaches the final beverage. This advanced filtration technology enhances the overall taste, purity, and safety of the dispensed beverage, making it a desirable choice for consumers seeking a premium drinking experience.

The electric pump plays a vital role in the beverage dispenser, facilitating the smooth flow and delivery of the desired beverage. It efficiently transfers the filtered water or other liquids from the water tank or cartridge storage to the dispensing outlet, ensuring a consistent and controlled dispensing process.

The beverage dispenser is equipped with a control panel. Referring to the schematic FIG. 1, it shall be understood that the control panel can control the electric pump.

In some embodiments, the control panel can operate all the components in the beverage dispenser. This interface allows users to adjust settings, select desired beverage options, control the dispensing process, and monitor the overall operation of the dispenser. The control panel enhances user convenience and ensures a user-centric experience.

The cartridge storage, acting as the secondary container, provides a convenient space for storing additional ingredients or flavorings. This allows users to easily add various cartridges containing flavor concentrates, nutritional supplements, or other liquid enhancers. By incorporating these cartridges, the beverage dispenser offers a wide range of customizable drink options to suit individual preferences. Preferably, these cartridges can be disposable or reusable, providing flexibility to suit different preferences and requirements.

The liquid dispensing apparatus is designed to include a cavity with three essential components: a first inlet, a second inlet, and an outlet. The operation of the liquid dispensing apparatus is the same as previously described. The first inlet establishes a fluidic connection with the water tank and is also connected to the outlet of the liquid dispensing apparatus. When the water flows from the water tank to the outlet of the liquid dispensing apparatus, it establishes a first passageway. On the other hand, the second inlet is fluidically linked to the cartridge storage, which, in turn, is connected to the cartridges containing flavor concentrates, nutritional supplements, or other liquid enhancers. Furthermore, the second inlet is also fluidically connected to the outlet of the liquid dispensing apparatus. When the contents flow from the cartridges to the outlet of the liquid dispensing apparatus, it establishes a second passageway. The outlet of the liquid dispensing apparatus is directly connected to the dispensing outlet. The operation of the liquid dispensing apparatus proceeds as follows: When the electric pump is activated to pump water from the water tank towards the dispensing outlet, the high velocity of the water within the liquid dispensing apparatus induces a venturi effect at the second inlet. As a result, the pressure at the second inlet decreases. This effect allows the contents within the cartridge to be drawn out and transferred from the cartridge towards the liquid dispensing apparatus via the second inlet. Once within the liquid dispensing apparatus, the contents of the cartridge come into contact with the flowing water and begin to mix. This process enables thorough mixing and integration of the contents with the water. Consequently, the water and the desired liquid, such as fruit juice, effectively combine and mix within the liquid dispensing apparatus. It is important to note that the strength of the venturi effect is directly influenced by the power or strength of the electric pump. Preferably, the liquid dispensing apparatus is disposable or replaceable, providing advantage to prohibit bacteria growth in the beverage dispenser.

In certain embodiments, the beverage dispenser features a configuration where the liquid dispensing apparatus, the cartridge storage, and the nano-filter are housed within the main body of the dispenser. This placement ensures a compact and streamlined design. The water tank is positioned externally, providing easy access for refilling purposes. It is important to note that the arrangement of these components may vary depending on specific requirements and design considerations. The actual placement and configuration of the cartridge storage, nano-filter, and water tank are determined based on practical needs, allowing for flexibility and optimization in the overall design of the beverage dispenser.

The beverage dispenser is equipped with various features to enhance functionality and control over the dispensed liquids. For example, a push button is provided. This button serves as the activation and deactivation control, allowing users to start and stop the dispensing process as needed.

Additionally, the dispenser features a turning dial that offers precise control over the mixing concentrate between the first and second liquids. By adjusting the dial, users can finely tune the ratio or strength of the blend according to their personal preferences. This level of control enables users to create a customized beverage with the precise balance of flavors and concentrations they desire. It is worth emphasizing that the turning dial plays a significant role in influencing the venturi effect occurring at the second inlet of the liquid dispensing apparatus. This is achieved by providing control over the volumetric flow of the contents from the cartridges to the liquid dispensing apparatus. By adjusting the turning dial, users can regulate the contents are drawn from the cartridges towards the liquid dispensing apparatus. This, in turn, affects the intensity of the venturi effect created at the second inlet. The ability to control the venturi effect through the turning dial offers users greater flexibility in customizing their beverage.

The combination of the push button, and turning dial empowers users to effortlessly dispense and customize their beverages to suit their taste preferences. Whether it's a refreshing mixture of water and flavorings, an energizing blend of energy drink concentrate and water, or any other desired combinations, the beverage dispenser provides a user-centric experience that allows for convenient, personalized, and adjustable liquid dispensing.

The above-described shall not be interpreted to be restricted by the examples or figures only. It is to be expressly understood, however, that such modifications and adaptations are within the scope of invention in this aspect. Thus, it is intended that the present disclosure cover such modifications and variations and their equivalents. Features illustrated or described as part of one embodiment can be used on another embodiment to yield a still further embodiment. For example, the embodiments of the adjustment means in FIGS. 1-19 can be used in the embodiments in the FIGS. 20-44. The turning dial described in the beverage machine can be used in the embodiments described in FIGS. 1-43 with adaptive modifications. Likewise, where appropriate, the terms used in the specification for “a cartridge storage” used in the embodiment in FIG. 44 can be interchangeable with the term “second container” used in the embodiments FIGS. 1-43. Components disclosed in this specification are examples only to explain the present invention, and shall not be construed as a limitation thereto. For manufacturing purpose, the disclosed individual components in this specification can be manufactured integrally. For instance, the lid member 808 and the outlet 816 can be integrally formed as one piece; the valve mounting member 804 and the mixing member 806, 906 can be integrally formed as one piece; the second container 812, 912 and the adjustment member 810, 910, can be integrally formed as one piece; and etc. On the contrary, for manufacturing purpose, the disclosed individual component in this specification can be manufactured into different parts. Configuration of the disclosed individual components in this context are examples only. The position, number, and shape of the components disclosed in this context are examples only. One skilled in the art shall not interpret it as a limitation to the present invention. For instance, those skilled in the art could modify the engaging member according to actual needs when the present invention is in use. The assembling of the disclosed individual components in this context are examples only. One skilled in the art shall not interpret it as a limitation to the present invention. For instance, the engagement such as press fitting between different engaging members as described above is an example only. Where appropriate, it shall be understood that those skilled in the art could use any other known means such as screwing for securing and/or connecting and/or assembling different components with each other.

What is claimed is:

1. A liquid dispensing apparatus, for use with a first container where a first liquid is contained, comprising:
(a) a second container where a second liquid is contained, said second container is provided with a container outlet for dispensing said second liquid; and
(b) a utility potion, comprising:
an outlet, for dispensing liquid;
a first inlet, collaboratively operating with a pressure valve for intaking said first liquid enabling a first passageway; and
a second inlet, operatively working with said container outlet, enabling a second passageway for controllably intaking said second liquid from said second container to said second inlet.

2. The liquid dispensing apparatus according to claim 1, wherein said pressure valve positioned adjacent said first inlet and works with a defined pressure, during a user sucks the first liquid at said outlet of said utility potion, the first liquid in said first container being flown through said pressure valve towards said outlet when the pressure-drop inside said utility potion exceeding the value of said defined pressure.

3. The liquid dispensing apparatus according to claim 2, wherein at the moment when the pressure-drop inside said utility potion exceeding the value of said defined pressure, the second liquid in said second container is selectively flowable through said container outlet towards said second inlet, thereby the first liquid and the second liquid being mixed in said utility potion.

4. The liquid dispensing apparatus according to claim 1, wherein said liquid dispensing apparatus comprising an adjustment means for adjusting the volumetric flow in said second passageway, thereby controllably adjusting said second liquid flowing through said container outlet towards said second inlet.

5. The liquid dispensing apparatus according to claim 1, wherein said second passageway is configurable to stop said second liquid flowing through said container outlet towards said second inlet.

6. The liquid dispensing apparatus according to claim 5, characterized in that, said liquid dispensing apparatus further comprising:
a buffer tank designed to provide a channel connecting said second inlet of said utility potion and said container outlet, said adjustment means is a T-shaped button having a top surface and a leg extending downwards therefrom, said leg is provided with a through-opening, said T-shaped button assembled to said buffer tank such that said leg of said T-shaped button is rotatable in said channel between a first configuration, where said through-opening being in fluid communication with said channel, and a second configuration, where said through-opening being not in fluid communication with said channel; or
a tube connecting said second inlet of said utility potion and said container outlet, said adjustment means is assembled to said liquid dispensing apparatus to encompass said tube, wherein said adjustment means comprising a slot and a handle slidable therein, said handle is provided with a protrusion such that said protrusion slidable over said tube between a first position and a second position, wherein the internal tubular cavity of said tube is smaller when said protrusion being at said first position comparing with said protrusion being at said second position; or
a tube connecting said second inlet of said utility potion and said container outlet, said adjustment means having an eccentric cylindrical profile being arranged adjacent said tube, and being rotatable with respect to said tube, wherein the internal tubular cavity of said tube is adjustable by rotating said adjustment means.

7. The liquid dispensing apparatus according to claim 1, wherein said utility potion is provided with a straw having a outlet connecting to said first inlet of said utility potion; and a first inlet extending toward the vicinity of the bottom of said first container.

8. The liquid dispensing apparatus according to claim 5, wherein said liquid dispensing apparatus further comprising a mixing chamber and a buffer tank, characterized in that, in said second passageway there is fluidic communication between said second container, said buffer tank, and said mixing chamber.

9. The liquid dispensing apparatus according to claim 8, wherein the liquid in either said first passageway or said second passageway flowing through said mixing chamber.

10. The liquid dispensing apparatus according to claim 9, wherein said utility portion is part of a lid member for said first container.

11. The liquid dispensing apparatus according to claim 5, wherein:
said liquid dispensing apparatus further comprising a mixing chamber and a buffer tank, wherein:
said utility portion is part of a lid member for said first container, wherein said lid member is profiled to accommodate said mixing chamber and said buffer tank;
said mixing member is adjacent said first inlet of said utility portion;
said buffer tank is adjacent said second inlet of said utility portion, and is provided with an inlet and an outlet;
said outlet of said utility portion has a cylindrical profile extending upwards from the top side of said utility portion;
said adjustment means is rotatable about said outlet of said utility portion and is provided with a through-opening, thereby said through-opening being slidable over said inlet of said buffer tank;
said second container is rotatable about said outlet of said utility portion and is positioned above said adjustment means, said container outlet is profiled to be received in said through-opening of said adjustment means.

12. The liquid dispensing apparatus according to claim 11, wherein the liquid in either said first passageway or said second passageway flowing through said mixing chamber.

13. The liquid dispensing apparatus according to claim 11, wherein said mixing member is profiled to accommodate a mounting member to which said pressure valve is mounted, and said pressure valve is positioned adjacent said first inlet.

14. The liquid dispensing apparatus according to claim 11, wherein the side of said buffer tank on which said inlet provided is designed to provide a groove, wherein said inlet of said buffer tank is provided at a first end of said groove.

15. The liquid dispensing apparatus according to claim 14, said groove of said buffer tank is provided with a second end, wherein the width of said groove is designed to be narrowing from said first end towards said second end; and/or the depth of the groove is designed to be decreasing from said first end towards said second end.

16. The liquid dispensing apparatus according to claim 11, wherein the top side of said utility portion is provided with a groove; said adjustment means is provided with a protrusion sized and shaped to slide in said groove of said utility portion.

17. The liquid dispensing apparatus according to claim 11, further comprising a ring member, wherein the internal surface of said ring member is provided with a first threading member, said second container is designed to provide a central bore in which said ring member is removably mounted, the peripheral of said outlet of said utility portion is provided with a second threading member engageable with said second threading member; thereby said second container mounted to said outlet of said utility portion via said ring member.

18. The liquid dispensing apparatus according to claim 17, by means of the coupling between said first threading member and said second threading member, said ring member being screwable upwards or downwards about said outlet of said utility portion, such that said ring member is configurable to position between a first position where said ring member and said second container is being closer to said utility portion and a second position where said ring member and said second container is being away from said utility portion.

19. The liquid dispensing apparatus according to claim 18, where said lid member is provided with a gas vent.

20. The liquid dispensing apparatus according to claim 1, wherein: the second liquid is in a form of disposable packaging, being received in said second container, and said first container is part of a beverage dispenser.

21. The liquid dispensing apparatus according to claim 20, said beverage dispenser further comprising a nano-filter and an electric pump, said pressure valve collaboratively operating with said electric pump, wherein said nano-filter comprising nanofiber and/or activated carbon materials.

22. The liquid dispensing apparatus according to claim 21, wherein said beverage dispenser is equipped with a control panel for operating said beverage dispenser and/or for operating said electric pump.

23. The liquid dispensing apparatus according to claim 21, wherein the adjustment means is a turning dial that offers control over the mixing concentrate between the first liquid and the second liquid.

24. The liquid dispensing apparatus according to claim 21, wherein said second container is disposable, providing advantage to prohibit bacteria growth in said beverage dispenser, and/or the tube connecting said electric pump and said first container is disposable, providing advantage to prohibit bacteria growth in said beverage dispenser, and/or the dispensing outlet of said beverage dispenser is disposable, providing advantage to prohibit bacteria growth in the beverage dispenser.
